(19) United States
(12) Patent Application Publication
(10) Pub. No.: US 2026/0032664 A1
(43) Pub. Date: Jan. 29, 2026

(54) ELECTRONIC DEVICE, COMMUNICATION METHOD AND STORAGE MEDIUM

(71) Applicant: Sony Group Corporation, Tokyo (JP)

(72) Inventor: Tingting FAN, Beijing (CN)

(73) Assignee: Sony Group Corporation, Tokyo (JP)

(21) Appl. No.: 19/120,815

(22) PCT Filed: Oct. 31, 2023
(86) PCT No.: PCT/CN2023/128185

§ 371 Date: Apr. 14, 2025

(30) Foreign Application Priority Data
Nov. 3, 2022 (CN) 202211369306.5

(51) Int. Cl. H04W 72/11; H04W 72/044; H04W 72/115; H04W 72/1263

(52) U.S. Cl. CPC H04W 72/11; H04W 72/044; H04W 72/115; H04W 72/1263

(57) ABSTRACT

The present disclosure relates to an electronic device, a communication method, and a storage medium. An electronic device for a control device comprises processing circuitry configured to send, to a user equipment (UE), a single Downlink Control Information (DCI) which indicates both validation of one or more Semi-Persistent Schedulings (SPSs) for the UE and validation of one or more Configured Grants (CGs) for the UE.

### CROSS REFERENCE TO RELATED APPLICATIONS

This application claims the priority of Chinese patent application No. 202211369306.5 entitled “ELECTRONIC DEVICE, COMMUNICATION METHOD AND STORAGE MEDIUM” filed on Nov. 3, 2022, which is incorporated herein by reference in its entirety.

### FIELD OF THE INVENTION

The present disclosure relates to an electronic device, a communication method, and a storage medium, and more particularly, the present disclosure relates to an electronic device, a communication method, and a storage medium that provide an enhanced scheduling design via Downlink Control Information (DCI).

### BACKGROUND

Benefiting from developments of wireless communication technology, a lot of application scenarios are receiving increasing attention. For example, eXtended Reality (XR) is one of the most important 5G media applications that are studied by the industry at present. The XR is a general term for all human-computer interactions that combine reality with virtuality and are generated wearable devices through computer technology, and may include different types of reality, such as Virtual Reality (VR), Augmented Reality (AR), Mixed Reality (MR) or the like. Such new applications also include Metaverse, Cloud Gaming, and so on.

Compared with traditional communication services, such new services as the XR have special service characteristics and design requirements for energy-saving and capacity enhancement. For example, the XR service may have characteristics like plentiful streams (such as I and P streams in downlink, control and video streams in uplink, etc.), a non-integer period for data of each stream (e.g., 30 frames per second (fps), 60 fps), variable packet size and Quality of Service (QoS) requirement, jitter in service arrival, and the like. These characteristics may pose a challenge to existing uplink and downlink resource configurations and validations.

Therefore, there is a need for enhanced uplink and downlink resource scheduling schemes to accommodate various existing or emerging service scenarios.

### SUMMARY OF THE INVENTION

The present disclosure provides a number of aspects. The above-described need may be met by applying one or more aspects of the present disclosure.

A brief summary regarding the present disclosure is given here to provide a basic understanding on some aspects of the present disclosure. However, it will be appreciated that the summary is not an exhaustive description of the present disclosure. It is not intended to identify key portions or important portions of the present disclosure, nor to limit the scope of the present disclosure. It aims at merely describing some concepts about the present disclosure in a simplified form and serves as a preorder of a more detailed description to be given later.

According to one aspect of the present disclosure, there is provided an electronic device for a control device, comprising processing circuitry configured to send, to a user equipment (UE), a single Downlink Control Information (DCI) which indicates both validation of one or more Semi-Persistent Schedulings (SPSs) for the UE and validation of one or more Configured Grants (CGs) for the UE.

According to another aspect of the present disclosure, there is provided an electronic device for a user equipment (UE), comprising processing circuitry configured to receive, from a control device, a single Downlink Control Information (DCI) which indicates both validation of one or more Semi-Persistent Schedulings (SPSs) for the UE and validation of one or more Configured Grant (CGs) for the UE.

According to another aspect of the present disclosure, there is provided a communication method, comprising sending, to a user equipment (UE), a single Downlink Control Information (DCI) which indicates both validation of one or more Semi-Persistent Schedulings (SPSs) for the UE and validation of one or more Configured Grants (CGs) for the UE.

According to another aspect of the present disclosure, there is provided a communication method, comprising: receiving, from a control device, a single Downlink Control Information (DCI) which indicates both validation of one or more Semi-Persistent Schedulings (SPSs) and validation of one or more Configured Grants (CGs) for the UE.

According to another aspect of the present disclosure, there is provided a non-transitory computer-readable storage medium storing executable instructions which, when executed, implement any of the communication methods as described above.

### DESCRIPTION OF THE DRAWINGS

A better understanding of the present disclosure may be achieved by referring to a detailed description given hereinafter in connection with accompanying drawings, wherein the same or similar reference signs are used to indicate the same or similar elements throughout the drawings. All figures are to be included in and form a part of the specification along with the following detailed descriptions, for further illustrating embodiments of the present disclosure and for explaining the theory and advantages of the present disclosure. Wherein,

FIG. 1 illustrates a simplified diagram of architecture of an NR communication system;

FIGS. 2A and 2B illustrate a NR radio protocol architecture for a user plane and a control plane, respectively;

FIG. 3 illustrates a frame structure for use in the 5G NR;

FIGS. 4A-4D illustrate a DCI format according to an exemplary embodiment of the present disclosure;

FIG. 5A illustrates Use Example 1 according to the present disclosure;

FIG. 5B illustrates a communication flow diagram according to Use Example 1;

FIG. 6A illustrates Use Example 2 according to the present disclosure;

FIG. 6B illustrates a communication flow diagram according to Use Example 2;

FIG. 7A illustrates Use Example 3 according to the present disclosure;

FIG. 7B illustrates a communication flow diagram according to Use Example 3;

FIG. 8A illustrates Use Example 4 according to the present disclosure;

FIG. 8B illustrates a communication flow diagram according to Use Example 4;

FIG. 8C illustrates Use Example 5 according to the present disclosure;

FIG. 8D illustrates a communication flow diagram according to Use Example 5;

FIG. 8E illustrates Use Example 6 according to the present disclosure;

FIG. 8F illustrates a communication flow diagram according to Use Example 6;

FIG. 9 illustrates Use Example 7 according to the present disclosure;

FIG. 10A illustrates an electronic device on the side of a user equipment according to the present disclosure;

FIG. 10B illustrates a communication method on the side of the user equipment according to the present disclosure;

FIG. 11A illustrates an electronic device on the side of a control device according to the present disclosure;

FIG. 11B illustrates a communication method on the side of the control device according to the present disclosure;

FIG. 12 illustrates an example block diagram of a computer that can be implemented as either the user equipment or the control device according to the present disclosure;

FIG. 13 illustrates a first example of schematic configuration of the base station according to the present disclosure;

FIG. 14 illustrates a second example of schematic configuration of the base station according to the present disclosure;

FIG. 15 illustrates an example of schematic configuration of a smartphone according to the present disclosure;

FIG. 16 illustrates an example of schematic configuration of an automobile navigation device according to the present disclosure;

Further features and aspects of the present disclosure will become apparent from the following description with reference to the attached drawings.

### DETAILED DESCRIPTION OF PREFERRED EMBODIMENTS

Various exemplary embodiments of the present disclosure will be described hereinafter with reference to the drawings. For purpose of clarity and simplicity, not all implementations of the embodiments are described in the specification. Note that, however, many settings specific to the implementations can be made in practicing the embodiments of the present disclosure according to specific requirements, so as to achieve specific goals of the developers, for example, to comply with constraints related to the device or service, which may vary from implementations. Moreover, it should be known that although the development job may be relatively complex and time-consuming, for those technicians in this filed benefiting from the present disclosure, such development is merely a routine task.

In addition, it should be noted that in some of the figures, only steps of a process and/or components of a device that are closely related to the technical contents according to the present disclosure are illustrated to avoid obscuring the present disclosure with unnecessary details, while in some other figures, existing steps of a process and/or components of a device are additionally shown for better understanding of the present disclosure.

The exemplary embodiments and application instances according to the present disclosure will be described in detail with reference to accompanying figures. Descriptions of the following exemplary embodiments are merely illustrative, and are not intended to limit the present disclosure or its applications in any way.

For the purpose of convenient explanation, various aspects of the present disclosure will be described below in context of the 5G NR. However, it should be noted that this is not a limitation on the scope of application of the present disclosure. One or more aspects of the present disclosure can also be applied to commonly used wireless communication systems, such as the 4G LTE/LTE-A, or various wireless communication systems to be developed in future. The architecture, entities, functions, processes and the like as described in the following description can be found in in the NR or other communication standard.

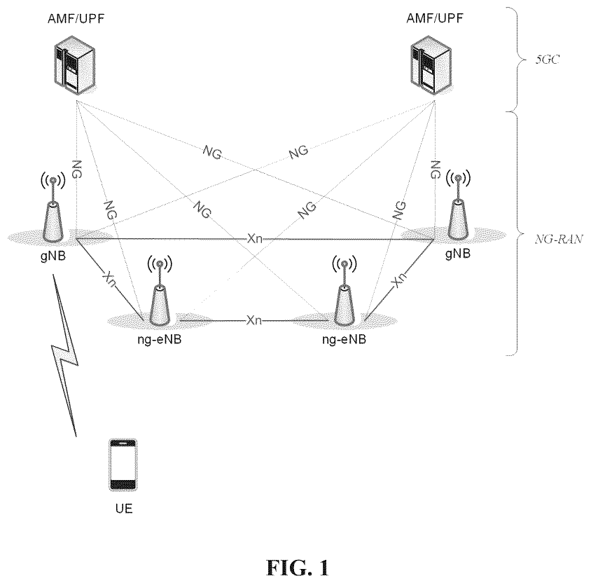

FIG. 1 is a simplified diagram illustrating architecture of the 5G NR communication system. As shown in FIG. 1, on the network side, radio access network (NG-RAN) nodes of the NR communication system include gNBs and ng-eNBs, wherein the gNB is a newly defined node in the 5G NR communication standard, and it is connected to a 5G core network (5GC) via an NG interface, and provides NR user plane and control plane protocols terminating with a terminal equipment (also referred to as “user equipment”, hereinafter simply referred to as “UE”); the ng-eNB is a node defined to be compatible with the 4G LTE communication system, and it may be upgradation of an evolved Node B (eNB) of the LTE radio access network, is connected to a 5G core network via an NG interface, and provides user plane and control plane protocols for evolved universal terrestrial radio access (E-UTRA) terminating with the UE. There is an Xn interface between the NG-RAN nodes (e.g., the gNBs and ng-eNBs) for intercommunication between the nodes. Hereinafter, the gNB and ng-eNB are collectively referred to as “base station”.

It should be noted, however, that the term “base station” used in the present disclosure is not limited to the above two types of nodes, but encompasses various control devices in the wireless communication system, and has a full breadth of its usual meaning. For example, in addition to the gNB and ng-eNB specified in the 5G communication standard, the “base station” may also be, for example, an eNB in the LTE communication system, a remote radio head, a wireless access point, a relay node, or a communication device that performs similar functions or an element thereof, depending on scenarios in which the present disclosure is applied. Application examples of the base station will be described in detail in the following section.

Moreover, the term “UE” used in the present disclosure has a full breadth of its usual meaning, including various terminal devices or in-vehicle devices communicating with the base station. For example, the UE may be terminal device such as a mobile phone, a laptop, a tablet, or an in-vehicle communication device, or an element thereof. Application examples of the UE will be described in detail in the following section.

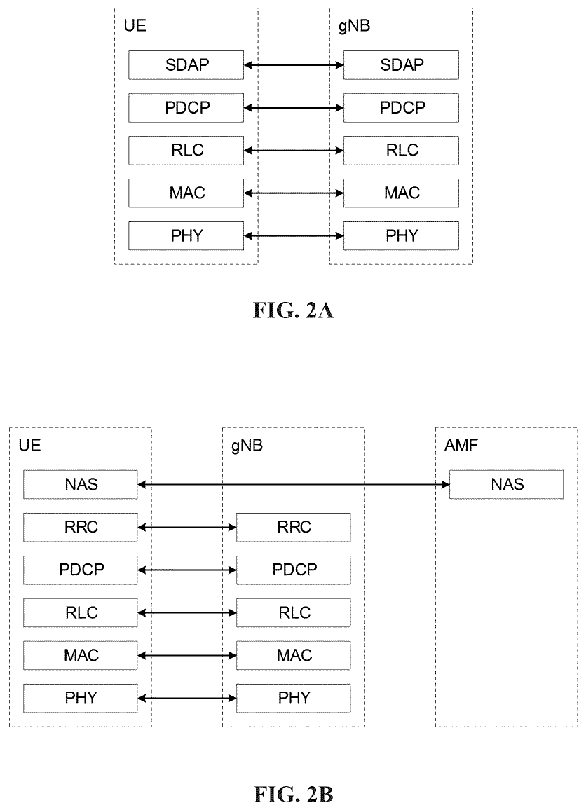

Next, an NR radio protocol architecture for the base station and the UE in FIG. 1 is described in connection with FIGS. 2A and 2B. FIG. 2A illustrates a radio protocol stack for a user plane of the UE and the base station, and FIG. 2B illustrates a radio protocol stack for a control plane of the UE and the base station.

Layer 1 (L1) of the radio protocol stack is the lowest layer, and is also called a physical layer. The L1 layer implements various physical-layer signal processing to provide transparent transmission for signals.

Layer 2 (L2) is above the physical layer and is responsible for managing radio links between the UE and the base station. In the user plane, the L2 layer includes a medium access control (MAC) sublayer, a radio link control (RLC) sublayer, a packet data convergence protocol (PDCP) sublayer, and a service data adaptation protocol (SDAP) sublayer. Moreover, in the control plane, the L2 layer includes a MAC sublayer, an RLC sublayer, and a PDCP sublayer. The relationship between these sublayer lies in that the physical layer provides a transport channel for the MAC sublayer, the MAC sublayer provides a logical channel for the RLC sublayer, the RLC sublayer provides a RLC channel for the PDCP sublayer, and the PDCP sublayer provides a radio bearer for the SDAP sublayer.

In the control plane, a Radio Resource Control (RRC) layer in Layer 3 (L3) is also included in the UE and the base station. The RRC layer is responsible for obtaining radio resources (i.e., radio bearers) and for configuring lower layers using RRC signaling. In addition, a Non-Access Stratum (NAS) control protocol in the UE performs functions such as authentication, mobility management, security control and the like.

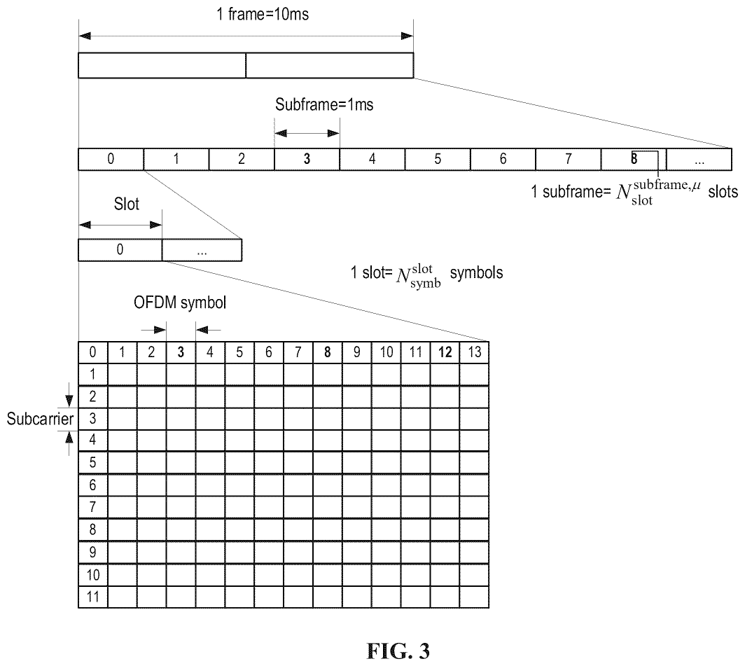

In the 5G NR, both downlink (DL) and uplink (UL) transmissions are organized into frames. FIG. 3 illustrates a diagram of a frame structure in the 5G communication system. As a fixed framework compatible with the LTE/LTE-A, the frame in the NR also has a duration of 10 ms and consist of 10 equally sized subframes, each of 1 ms. Different from the LTE/LTE-A, the frame structure in the NR has a flexible architecture that depends on a subcarrier spacing. Each subframe has configurable

$${N}_{slot}^{subframe , μ}$$

slots, such as 1, 2, 4, 8, or 16. Each slot also has configurable

$${N}_{symb}^{slot}$$

OFDM symbols. For normal cyclic prefix, each slot contains 14 consecutive OFDM symbols, and for extended cyclic prefix, each slot contains 12 consecutive OFDM symbols. In the frequency-domain dimension, each slot contains several resource blocks (RBs), and each resource block contains 12 consecutive subcarriers in the frequency domain. As a result, resource elements (REs) in the slot can be represented using a resource grid, as shown in FIG. 3. The resource blocks usable for uplink and downlink transmissions can be divided into a data segment and a control segment. The resource elements in the control segment can be allocated for transmissions of control information, while the data segment includes all resource elements not included in the control segment for transmission of data to the UE or base station.

Scheduling of time-domain resources can be performed at various granularities, such as a single slot, multiple consecutive slots (also known as aggregated slots), or some OFDM symbols within a single slot (also known as a mini slot). Scheduling of frequency-domain resources is generally in units of RBs. Depending on whether the scheduled RBs are continuous or not, there may be different types.

The base station can send a DCI via a Physical Downlink Control Channel (PDCCH) to indicate time-frequency transmission resources scheduled for an uplink transmission or a downlink transmission. The base station can schedule transmission resources for the UE in each Transmission Time Interval (TTI), and this scheduling method is referred to as Dynamic Scheduling (DG).

To save PDCCH resources, the base station can also adopt a non-dynamic scheduling method by sending a periodically valid scheduling command to the UE, thereby allocating transmission resources to the UE periodically. For Physical Downlink Shared Channel (PDSCH) transmissions on the downlink, Semi-Persistent Scheduling (SPS), also known as Semi-Static scheduling, can be used. In short, the base station can send a downlink assignment (DL assignment) to the UE via a PDCCH, allowing the UE to use the allocated SPS resources to receive data in every period without requiring the base station to send a scheduling command each time. For Physical Uplink Shared Channel (PUSCH) transmissions on the uplink, Configured Grant (CG) can be used, that is, the base station can configure an uplink grant (UL grant) for the UE through a higher-layer parameter, such as configuredGrantConfig, to indicate periodic uplink transmission resources usable by the UE. There are two types of CG: CG Type 1, in which the UE can directly use the configured resources to upload data without activation by a DCI; and CG Type 2, in which the UE needs the base station to activate the uplink grant before using the configured resources.

The base station can send validation for SPS or CG (Type 2) to the UE via a DCI carried on the PDCCH. As used in the present disclosure, “validation” includes activation or release, wherein the release is sometimes referred to as deactivation. To receive the DCI, the UE can monitor PDCCH candidates within one or more configured search space sets. The set of PDCCH candidates to be monitored by the UE is defined according to the PDCCH search space set. The search space set can be a Common Search Space (CSS) set or a User-specific Search Space (USS) set. Based on information indicated in the received DCI, the UE can accordingly validate (activate/release) the DL SPS or UL CG.

Conventionally, a DCI may be used for either the validation of SPS or for the validation of CG. Specifically, a downlink DCI (DL DCI) may be used to activate an SPS, or may be used to release k (k≥1, wherein a value of k is configurable via a RRC parameter) SPSs; and an uplink DCI (UL DCI) may be used to activate a CG, or may be used to release k (k≥1) CGs.

However, there may be cases where both of SPS and CG are required to validated (activated/released) simultaneously. As a non-limiting example, certain services (such as the XR service) may involve a large number of uplink and downlink data streams, and thus require configuration for multiple SPSs and CGs. It is desirable to achieve efficient use of SPS/CG resources through flexible activation and release, while meeting data transmission latency and power consumption reduction. In addition, there may be cases where activation and release of SPSs are performed simultaneously, or activation and release of CGs are performed simultaneously. Conventionally, the activation and release of SPSs/CGs require separate DCIs, which results in a large number of configurations for SPSs and CGs and transmissions of DCIs for real-time/flexible SPS/CG validations. For blind detection of each of the DCIs, the UE needs to traverse the PDCCH search space, causing significant energy consumption, which is undesirable, especially for energy-constrained UEs.

In view of the above, an improved PDCCH validation mechanism is proposed in the present disclosure, in order to achieve flexible validation of SPS and/or CG, thereby improving an efficiency of DCI indication. According to embodiments of the present disclosure, the base station uses a single DCI to indicate validation of various combinations of SPS and CG for the UE.

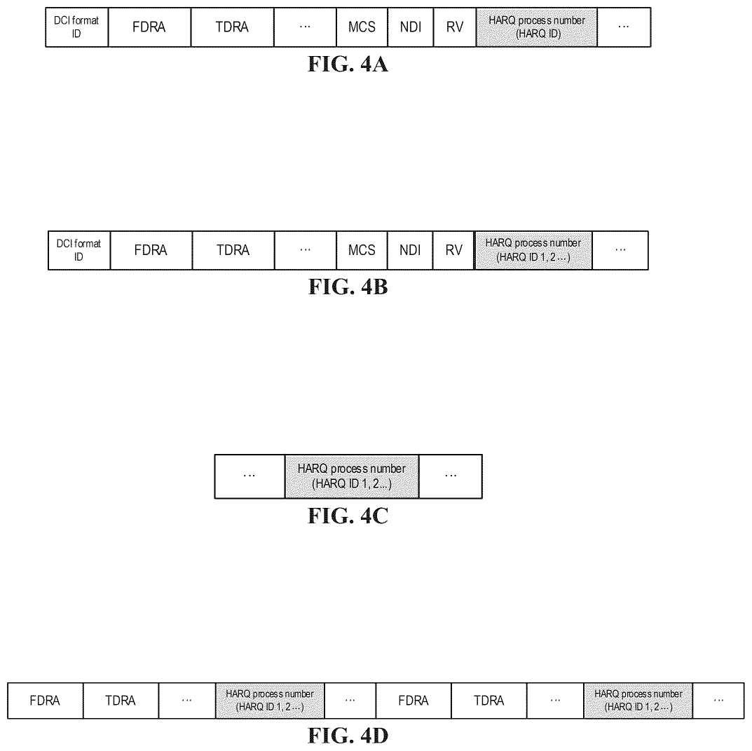

In an exemplary embodiment, the base station supports simultaneous release of SPS and CG by using a single DCI to indicate a release combination of SPS and CG configured for the UE. Specifically, the base station configures at least one SPS&CG release combination for the UE through a RRC parameter, where each release combination can include one or more indices (SPS indices) identifying SPSs to be released and one or more indices (CG indices) identifying CGs to be released. The base station can then reuse a conventional DCI format (such as DL DCI format 1_0, 1_1 or 1_2, UL DCI format 0_0, 0_1 or 0_2, etc.) to indicate one of the release combinations, without modification to the DCI format. FIG. 4A schematically illustrates some fields of the DCI. It should be understood that the fields as shown do not represent all fields of the DCI, and depending on a different DCI format and different scrambling, some field or fields may not exist. According to this exemplary embodiment, “SPS release+CG release” can be indicated using a single DCI.

As an example, the base station can modify/extend information element sps-ConfigDeactivationStateList, which indicates a list of deactivation states, in the RRC parameter BWP-DownlinkDedicated. Conventionally, each deactivation state is mapped to one or more SPS configurations to be deactivated. However, according to this exemplary embodiment, at least one deactivation state can be mapped to a set of SPS configurations (containing one or more SPS indices) and a set of CG configurations (containing one or more CG indices). The base station can then send a DCI, and a corresponding field (e.g., “HARQ process number” field) in the DCI is set to indicate a specific value that corresponds to an entry of certain deactivation state, so that the UE will deactivate (release) the set of SPSs and the set of CGs indicated in the deactivation state. In the case of extending the deactivation state list, if the number of entries in the list exceeds a limit (e.g., a maximum number of the HARQ processes, such as 16 or 32), the number of bits required by the “HARQ process number” field in the DCI may need to be increased, for example, from 4 or 5 bits to more bits, such as to ceil[log 2(size of (sps-ConfigDeactivationStateList))], where the function ceil[x] denotes the smallest integer greater than or equal to x, so that the “HARQ process number” in the DCI can indicate all of the deactivation states listed in the sps-ConfigDeactivationStateList.

As another example, the base station can modify/extend information element ConfiguredGrantConfigType2DeactivationStateList, which indicates a list of deactivation states, in the RRC parameter BWP-UplinkDedicated. Conventionally, each of the deactivation states is mapped to one or more CG configurations to be deactivated. However, according to this exemplary embodiment, at least one deactivation state can be mapped to a set of CG configurations (containing one or more CG indices) and a set of SPS configurations (containing one or more SPS indices). The base station can then send a DCI, and a corresponding field (e.g., “HARQ process number” field) in the DCI is set to indicate a specific value that corresponds to a certain deactivation state, so that the UE will deactivate (release) the set of CGs and the set of SPSs indicated in the deactivation state. If the number of entries in the list exceeds a limit (e.g., a maximum number of the HARQ processes, such as 16 or 32), the number of bits required by the “HARQ process number” field in the DCI may need to be increased, such as from 4 or 5 bits to more bits, such as to ceil[log 2(size of (ConfiguredGrantConfigType2DeactivationStateList))], so that the “HARQ process number” in the DCI can indicate all of the deactivation states listed in the ConfiguredGrantConfigType2DeactivationStateList.

Alternatively, besides reusing existing RRC parameters, new RRC parameters may also be defined. For example, DLCGType2sps-ConfigDeactivationStateList and ULCGType2sps-ConfigDeactivationStateList can be defined, which can specify at least one combination containing CG indices and SPS indices. The base station can then use a corresponding field (e.g., “HARQ process number” field) in the DL DCI and in the UL DCI to indicate one of the combinations, so that the UE can release the CGs and SPSs involved in that combination.

In another exemplary embodiment, the base station indicates the flexible validation of SPS and/or CG by modifying the conventional DCI format to include a HARQ ID associated with the SPS and/or CG to be validated. Compared to the conventional DCI format, the “HARQ process number” field in the DCI according to this exemplary embodiment can include two or more HARQ IDs, as shown in FIG. 4B.

As an example, the conventional DL DCI used for SPS validation (e.g., DCI format 1_0, 1_1, or 1_2) may be modified so that its “HARQ process number” field not only includes a HARQ ID associated with a SPS to be validated, but can also include one or more additional HARQ IDs associated with SPS(s) or CG(s) to be released. In other words, the “HARQ process number” field can include at least two HARQ IDs, where the first HARQ ID indicates activation or release of a corresponding SPS according to configuration of the conventional DL DCI, and the subsequent HARQ ID(s) additionally indicate release of corresponding SPS(s) and/or CG(s). For example, the subsequent HARQ IDs can be associated with one or more CGs, or one or more other SPSs and one or more CGs that are to be released.

It should be noted that, although the above examples employ a HARQ ID to identify the associated SPS or CG, this is merely exemplary but not limiting. The DCI can also include other identification information for the SPSs or CGs, such as an index corresponding to a deactivation state in the above sps-ConfigDeactivationStateList, ConfiguredGrantConfigType2DeactivationStateList, DLCGType2sps-ConfigDeactivationStateList, or ULCGType2sps-ConfigDeactivationStateList to indicate a corresponding set of SPSs, set of CGs, or a combined set of SPSs and CGs. In this example, the DL DCI can be modified to not only include, for example, the HARQ ID for the SPS to be activated or released, but also can include the index of the deactivation state associated with the SPS(s) or CG(s) to be released. Such identification information can be included in the “HARQ process number” field of the DCI, for example.

As a variant, the DCI according to this embodiment can implement validation of an SPS and release of further SPS(s) simultaneously. For example, the “HARQ process number” field of the DL DCI can be extended to include multiple HARQ IDs associated with the SPSs, where the first HARQ ID indicates the validation (activation/release) of an associated SPS, and subsequent HARQ ID(s) indicate the release of the further SPS(s). Alternatively, in addition to identification information (e.g., HARQ ID) of the SPS to be activated or released, the DL DCI can include an index of a deactivation state associated with one or more SPSs to be released in sps-ConfigDeactivationStateList, for example. In this example, the number of increased bits can be equal to the number of bits for the extra HARQ IDs or ceil[log 2(size of (sps-ConfigDeactivationStateList))].

As an example, the conventional UL DCI used for CG validation (e.g., DCI format 0_0, 0_1, or 0_2) can be modified so that its “HARQ process number” field not only includes a HARQ ID associated with a CG to be validated, but can also include one or more additional HARQ IDs associated with CG(s) or SPS(s) to be released. In other words, the “HARQ process number” field may include at least two HARQ IDs, where the first HARQ ID indicates activation or release of a corresponding CG according to configuration of the conventional UL DCI, and subsequent HARQ ID(s) additionally indicate release of SPS(s) and/or CG(s). For example, the subsequent HARQ IDs can be associated with one or more SPSs, or one or more other CGs and one or more SPSs that are to be released.

As a variant, the DCI according to this embodiment can implement validation of an CG and release of further CG(s) simultaneously. For example, the “HARQ process number” field of the UL DCI can be extended to include multiple HARQ IDs associated with CGs, where the first HARQ ID indicates validation (activation/release) of an associated CG, and subsequent HARQ ID(s) indicate release of the further CG(s). Alternatively, in addition to identification information (e.g., HARQ ID) of the CG to be activated or released, the UL DCI can include an index of a deactivation state associated with one or more CGs to be released in ConfiguredGrantConfigType2DeactivationStateList, for example. In this example, the number of increased bits can be equal to the number of bits for the extra HARQ IDs or ceil[log 2(size of (ConfiguredGrantConfigType2DeactivationStateList))].

According to this exemplary embodiment, a single DCI can be used to indicate “SPS validation (activation/release)+CG release”, “CG validation (activation/release)+SPS release”, and optionally, can also be used to indicate “SPS validation (activation/release)+SPS release”, “CG validation (activation/release)+CG release”. Which specific combination format may be configured via RRC, or activated via MAC CE, or indicated by adding a bit in DCI, or a certain combination of these three methods, namely, RRC configuration, MAC CE activation, and DCI indication, as long as the base station and UE can reach a consensus on the understanding of corresponding field in the DCI. In general, a DL DCI can be used to implement “SPS validation+SPS release” or “SPS validation+CG release”, and a UL DCI can be used to implement “CG validation+SPS release” or “CG validation+CG release”. In terms of modification to the standard, a DL DCI can be used to implement “SPS validation+SPS release”, and a UL DCI can be used to implement “CG validation+CG release”.

In another exemplary embodiment, a new simplified DCI format can be defined mainly for the function of simultaneous release of SPS(s) and CG(s). This simplified DCI remains using CS-RNTI (Configuration Scheduling-Radio Network Temporary Identity) for scrambling, and its “HARQ process number” field includes multiple HARQ IDs associated with one or more SPSs and one or more CGs to be released. To save a size of the DCI and facilitate fast blind detection, the simplified DCI may omit other fields, including but not limited to at least one of the following fields:
DCI format identifier;
New Data Indicator (NDI);
Data Field Indicator (FDI) flag;
Time-domain resource assignment;
Frequency-domain resource assignment;
PDSCH to HARQ feedback timing indicator;
Redundancy Version (RV);
Modulation and Coding Scheme (MCS).

FIG. 4C schematically illustrates a DCI according to this exemplary embodiment. Since this simplified DCI is a newly defined format, the base station needs to preconfigure the DCI format to the UE through a higher-layer parameter, and configure PDCCH candidates carrying the DCI in a search space of the UE. As a result, the UE will be able to receive and understand this kind of DCI, and release all of the SPS(s) and CG(s) associated with the HARQ IDs included in the “HARQ process number” field therein. According to this exemplary embodiment, a single DCI can be used to indicate “SPS release+CG release”.

As another exemplary embodiment, a new DCI format can be defined by synthesizing conventional DL DCIs or conventional UL DCIs. In other words, the synthesized DCI can contain both validation of one or more SPSs and validation of one or more CGs, and may assume the function of scheduling a PDSCH and a PUSCH.

Here, the “synthesizing” can be achieved in various ways. In the simplest example, the synthesized DCI can be formed by concatenating DL DCI(s) indicating SPS(s) (e.g., DCI format 10, 1_1, or 12) and UL DCI(s) indicating CG(s) (e.g., DCI format 0_0, 0_1, or 0_2), and include all of their non-repeated fields.

Preferably, the synthesized DCI may omit some fields through a special design. For example, the designed DCI may not include at least one of the following fields:
DCI format identifier. It may be assumed by default that the front part of scheduling information in the DCI is about UL, and the latter part is about DL;
Redundancy Version (RV). During the activation and release of SPS/CG, the RV field can be omitted instead of being set to all zeros;
New Data Indicator (NDI). During the activation and release of SPS/CG, the NDI field can be omitted instead of being set to zero;
Data Field Indicator (DFI) flag. During the activation and release of SPS/CG, the DFI field can be omitted instead of being set to zero;

It should be noted that the fields that can be omitted in the DCI according to this exemplary embodiment may not be limited to the four fields above. When the DCI is mainly used to indicate the validation of SPS and CG, according to the standard, some fields may need to be set to 0 or 1 by default, and these fields may be omitted to reduce the size of the DCI in the synthesizing. FIG. 4D schematically illustrates the synthesized DCI according to this exemplary embodiment.

Similarly, since the synthesized DCI is a newly defined format, the base station needs to preconfigure the DCI format to the UE through a higher-layer parameter, and configure PDCCH candidates carrying the DCI in a search space of the UE. As a result, the UE will be able to receive and understand this kind of DCI, and release all of the SPS and CG associated with HARQ IDs included in the “HARQ process number” field therein. According to this exemplary embodiment, a single DCI can be used to indicate “SPS validation (activation or release)+CG validation (activation or release)”. Compare to sending separate DL DCI and UL DCI, using the DCI according to this exemplary embodiment can reduce the number of PDCCH blind detections, which helps energy saving.

The use of simultaneous SPS&CG validations according to the embodiments of the present disclosure will be described below in conjunction with an illustrative XR service scenario. It should be noted that the XR service is merely an example for easy understanding and is not intended to limit the scope of application of the technology proposed in the present disclosure.

As the demand for XR services increases, a project has been launched to explore how the radio access network (RAN) can better support XR services. In the XR services, uplink and downlink data streams need to be aligned and are primarily transmitted during Discontinuous Reception (DRX) ON periods, and a low latency for data processing is required. The XR services are generally characterized by the following characteristics:
1) Since the data streams are periodic, SPS and CG can be configured to avoid the power consumption caused by frequent DCI transmissions in the DG;
2) Since the periods of the data streams are non-integer (30 fps corresponds to a period of 33.33 ms, and 60 fps corresponds to a period of 16.67 ms), the existing standard does not support configuring SPS and CG in a non-integer period. Therefore, multiple SPSs/CGs can be configured (e.g., three SPS/CG indexes can be configured in 50 ms, all with a period of 50 ms, but starting at 0 ms, 16 ms, and 33 ms within the 50 ms), such that the period is aligned with the service within the 50 ms, and no latency is caused;
3) Since the packet size of each stream is variable, multiple DCIs for SPS/CG validation may be required for each SPS/CG configured for each stream to adjust the SPS/CG resources to match actually arrived data;
4) Since there are multiple streams, the need for SPS/CG configurations and their DCI validations is increased;
5) Due to presence of jitters in certain service streams, the configuration and validation of SPS/CG may occur at uncertain times, exhibiting flexibility and real-time characteristics.

In summary, it turns out a large number of indications for SPS and CG configurations and transmissions of DCIs for real-time/flexible validation of SPS/CG. Without support for the combination of the simultaneous activation and release of SPS and CG, the large number of separate DCI indications will result in significant energy consumption. Consequently, the DCI according to the embodiments of the present disclosure can be employed to enable simultaneous validation of SPS and CG.

An AR scenario model is assumed here for better understanding. Two DL data streams (I stream and P stream) and at least one UL data stream are included in data streams of the service. Main service model parameters for each DL data stream are: 60 fps, jitter=[−4 ms, 4 ms], and packet size following a Truncated Gaussian Distribution; and service model parameters for the UL data stream are: 60 fps, jitter with a truncated range of [−4 ms, 4 ms], mean=0 ms, standard deviation=2 ms, and packet size following a Truncated Gaussian Distribution.

Based on the 60 fps framerate of each data stream in this scenario, the period of data arrival is 1/60=16.67 ms. Accordingly, DRX parameters can be configured as follows: DRX period=17 ms, DRX ON Duration=10 ms, and Opportunity for DRX=7 ms. The system adopts a subcarrier spacing (SCS) of 30 kHz, which corresponds to a slot length of 0.5 ms. The frame structure is DDDSU, where every five slots consist of three DL slots (D), one DL/UL mixed and guard slot (S), and one UL slot (U) in this order. The S slot is structured as 10D:2F:2U.

### Use Example 1

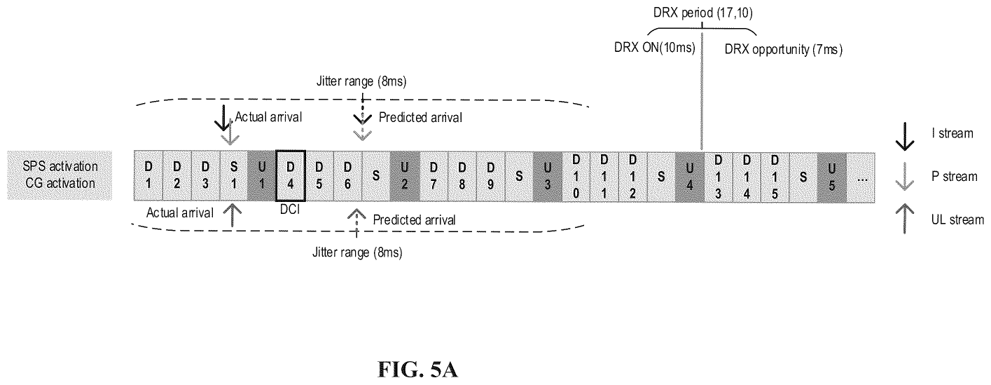

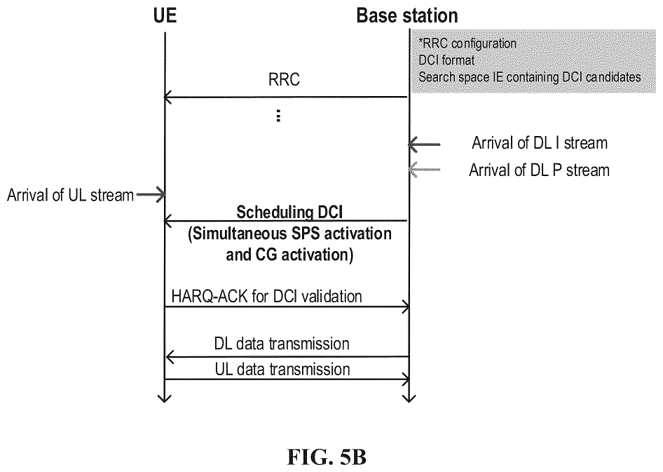

As illustrated in FIG. 5A, assume that DL I stream and P stream arrive early in slot S1, and UL data stream arrives early in slot S1. If the base station needs to be informed of the arrival of the UL traffic stream by the UE sending a Scheduling Request (SR), taking into account a certain processing latency and to reduce the overhead and power consumption for blind detection of DCIs for activating SPS and CG separately, the base station can send a DCI according to at least one of the exemplary embodiments described above to activate SPS and CG simultaneously, for example, in slot D4.

FIG. 5B illustrates a communication flow diagram according to Use Example 1. As shown, the base station can configure a DCI format that may be used later for the UE via RRC signaling, such as the DCI according to the exemplary embodiments of the present disclosure, as well as a search space including PDCCH candidates for carrying the DCI. In response to the arrival of DL and UL data streams, the base station sends a single scheduling DCI to the UE indicating activation of SPS and activation of CG, such as the DCI according to at least one of the exemplary embodiments described above, and receives a HARQ-ACK for the DCI. Consequently, the UE can receive DL data on the activated SPS PDSCH and transmit UL data using the activated CG PUSCH.

### Use Example 2

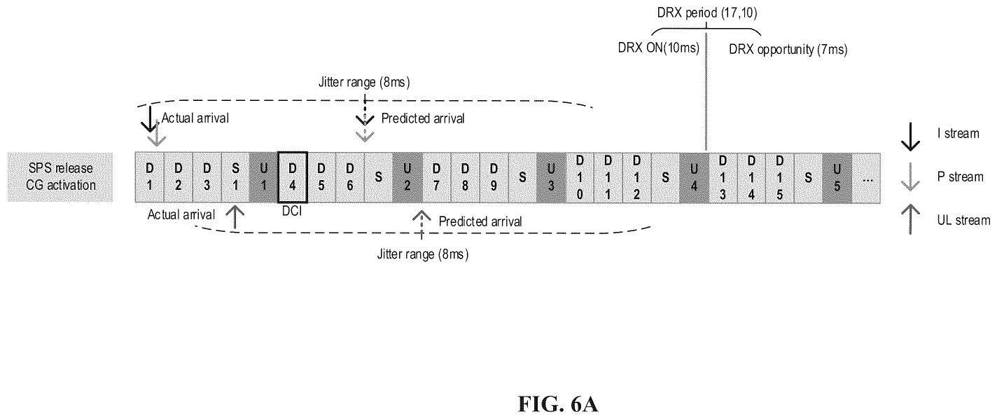

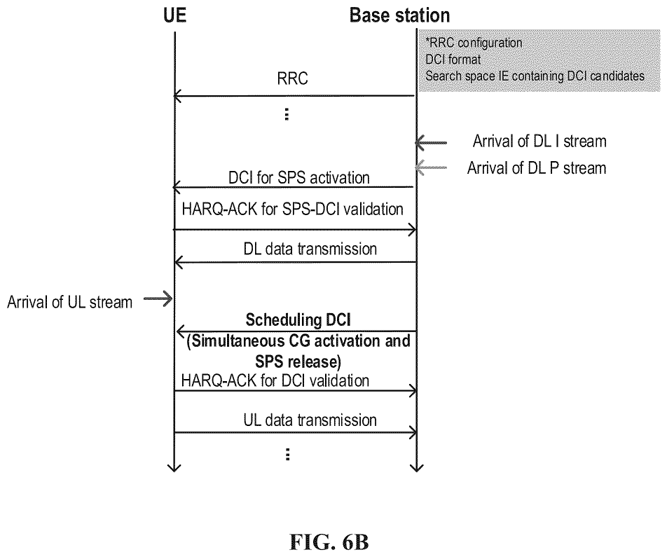

As illustrated in FIG. 6A, assume that DL I stream and P stream arrive early in slot D1, and UL data stream arrives early in slot S1. If partial SPSs are activated in slots D1 or D2 for transmitting a large amount of DL data, and when the packet in this downlink transmission is small, the DL data may have been substantially transmitted until slot S1 in combination with some dynamic scheduling (DG) transmissions, and thus some of the SPSs need to be released for adapting to the remaining small amount of DL data. Considering a certain scheduling delay and to reduce the overhead and power consumption for blind detection of DCIs for releasing SPS and activating CG separately, the base station can send a DCI according to at least one of the exemplary embodiments described above to release SPS and activate CG simultaneously, for example, in slot D4.

FIG. 6B illustrates a communication flow diagram according to Use Example 2. As shown, the base station can configure a DCI format that may be used later for the UE via RRC signaling, such as the DCI according to the exemplary embodiments of the present disclosure, as well as a search space including PDCCH candidates for carrying the DCI. In response to the arrival of DL data stream, the base station sends a DCI to the UE indicating activation of SPS and receives a HARQ-ACK for the DCI. Subsequently, the UE can receive the DL data on the activated SPS PDSCH. As the UL data arrives, the base station sends a single scheduling DCI to the UE indicating release of SPS and activation of CG, such as the DCI according to at least one of the exemplary embodiments described above. As a result, the SPS is released, and the UE transmits the UL data using the activated CG PUSCH.

### Use Example 3

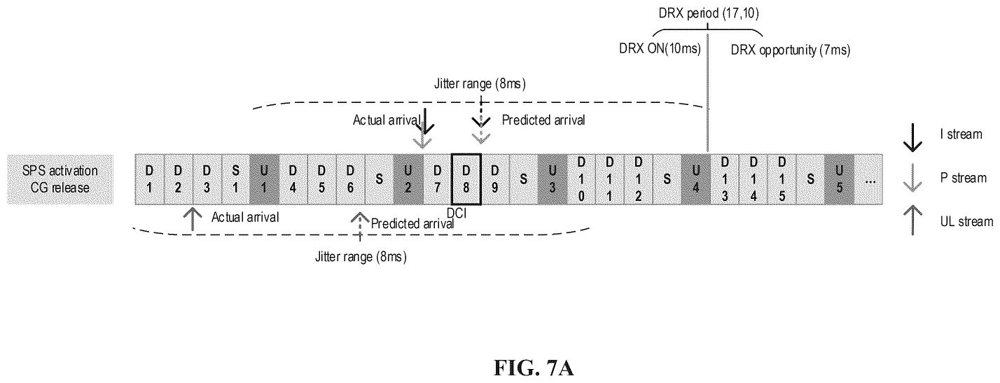

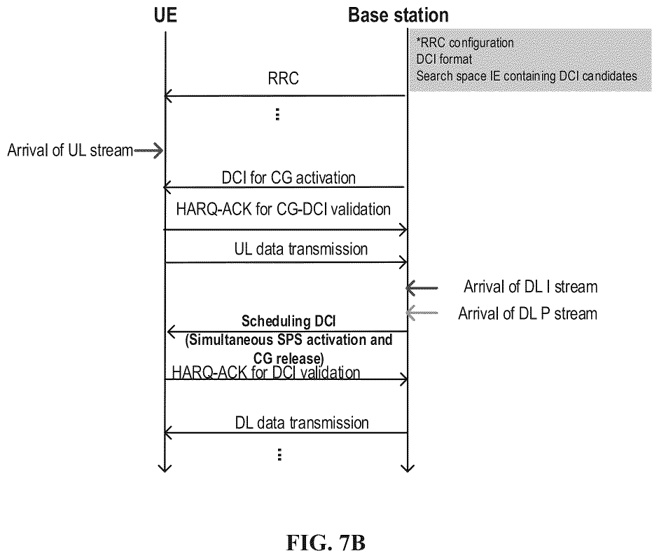

As illustrated in FIG. 7A, assume that DL I stream and P stream arrive late in slot D7, while UL data stream arrives early in slot D2. If some CGs are activated in slots D3 or D4 for transmitting UL data, the UL data may have been substantially transmitted until slot D7, and thus some of the CGs need to be released for adapting to the remaining small amount of UL data. Considering a certain scheduling delay and to reduce the overhead and power consumption for blind detection of DCIs for activating SPS and releasing CG separately, a DCI can be sent to activate SPS and release CG simultaneously, for example, in slot D8 (or D7).

FIG. 7B illustrates a communication flow diagram according to Use Example 3. As shown, the base station can configure a DCI format that may be used later for the UE via RRC signaling, such as the DCI described in the exemplary embodiments of the present disclosure, as well as a search space including PDCCH candidates for carrying the DCI. In response to the arrival of UL data steam, the base station sends a DCI to the UE indicating activation of CG, and receives a HARQ-ACK for the DCI. Subsequently, the UE can transmit the UL data on the activated CG PUSCH. As DL data arrives, the base station sends a single scheduling DCI to the UE indicating release of CG and activation of SPS, such as the DCI according to at least one of the exemplary embodiments described above. As a result, the CG is released, and the UE receives the DL data on the activated SPS PDSCH.

### Use Example 4

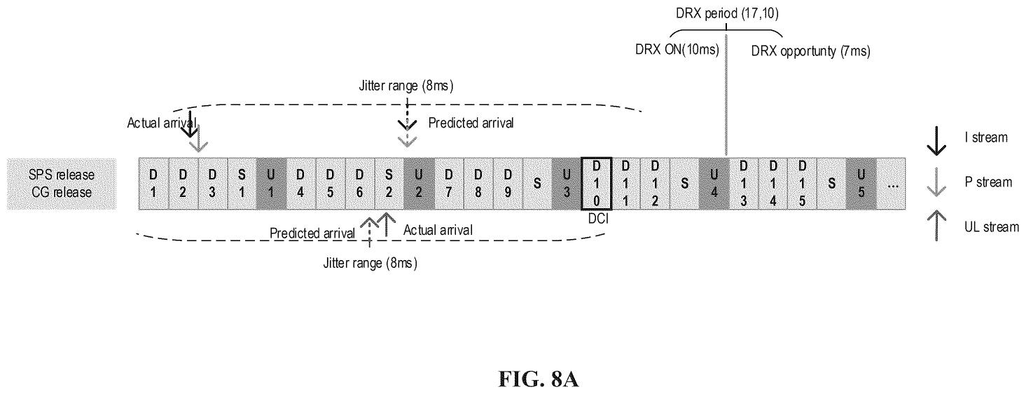

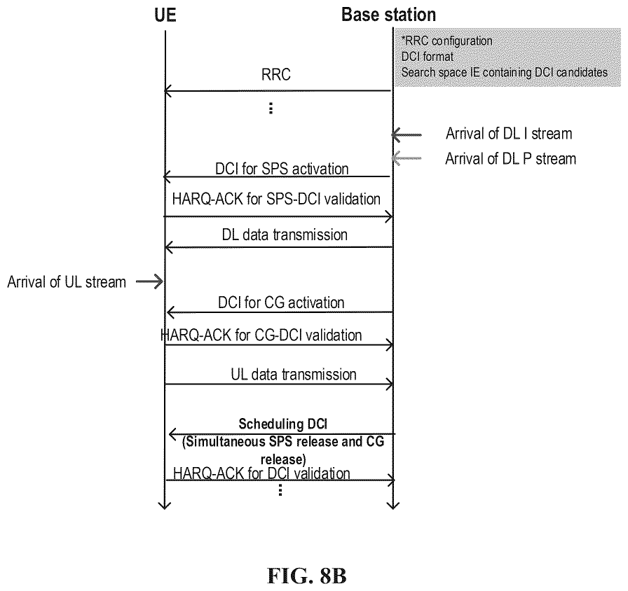

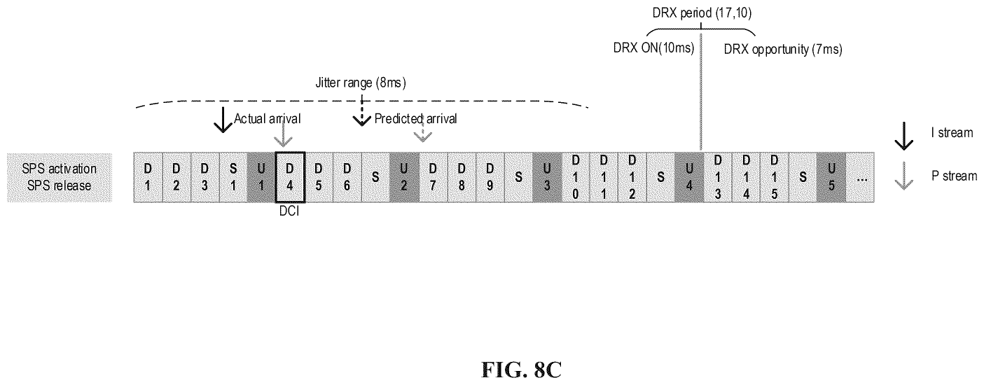

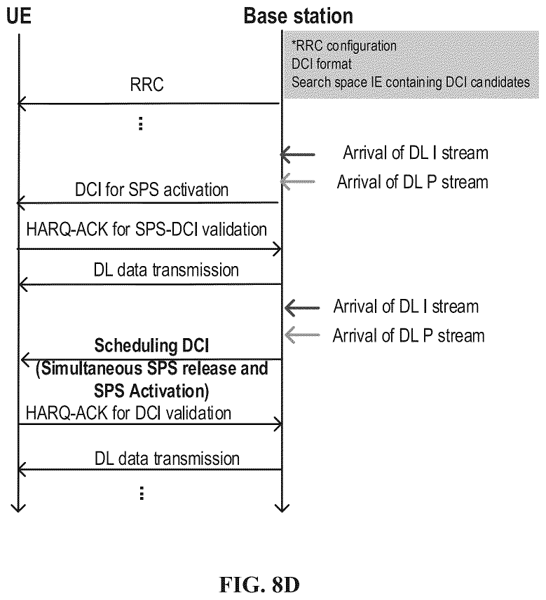

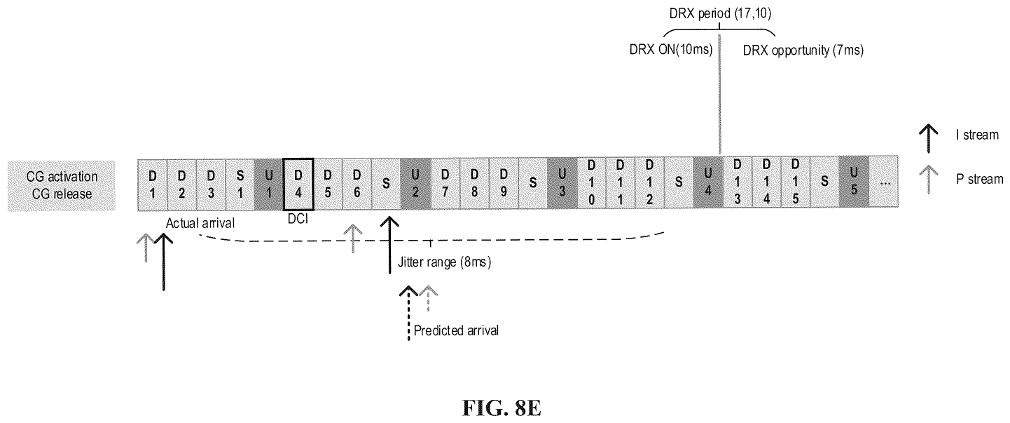

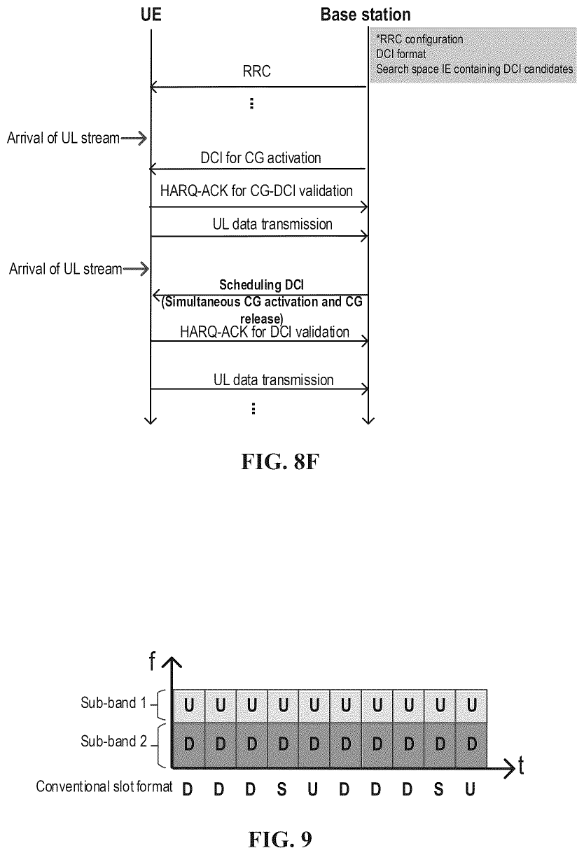

As illustrated in FIG. 8A, assume that DL I stream and P stream arrive early in slot D2, and UL data stream arrives late in slot S2. If some SPSs may have been activated in slot D3 for transmitting DL data, and some CGs are activated in slot D7 for transmitting UL data, the DL and UL data may have been substantially transmitted until slot D10. Thus, the SPS and CG need to be released. To reduce the overhead and power consumption for blind detection of DCIs for releasing the SPS and the CG separately, the base station can send a DCI to release SPS and CG simultaneously, for example, in slot D10.

FIG. 8B illustrates a communication flow diagram according to Use Example 4. As shown, the base station can configure a DCI format that may be used later for the UE via RRC signaling, such as the DCI according to the exemplary embodiments of the present disclosure, as well as a search space including PDCCH candidates for carrying the DCI. In response to the arrival of DL data steam, the base station sends a DCI to the UE indicating activation of SPS, and receives a HARQ-ACK for the DCI. Subsequently, the UE can receive the DL data on the activated SPS PDSCH. As UL data arrives, the base station sends a DCI to the UE indicating activation of CG and receives a HARQ-ACK for the DCI. The UE can transmit the UL data on the activated CG PUSCH. Subsequently, the base station sends a single scheduling DCI to the UE indicating release of CG and SPS, such as the DCI according to at least one of the exemplary embodiments described above. As a result, the CG and SPS are released.

### Use Example 5

This use example is suitable for varying data amount in downlink transmission. As illustrated in FIG. 8C, assume that I stream has a large data amount, and P stream has a small data amount in current downlink transmission. However, the I stream to be transmitted in subsequent slots has a small data amount, whereas the P stream has a large data amount. In this case, previously configured SPS may no longer be suitable after the change in traffic amount, and thus it is necessary to deactivate the previously configured SPS and reactivate a SPS that aligns with the subsequent traffic. At this time, according to the existing standard, two DCIs are required to separately indicate activation of the new SPS and release of the previous SPS, resulting in a significant signaling overhead and power consumption for blind detection of the DCIs. In view of this, the base station may send a DCI to activate SPS and release SPS simultaneously, for example, in slot D4.

FIG. 8D illustrates a communication flow diagram according to Use Example 5. As shown, the base station can configure a DCI format that may be used later for the UE via RRC signaling, such as the DCI according to the exemplary embodiments of the present disclosure, as well as a search space including PDCCH candidates for carrying the DCI. In response to the arrival of DL data stream, the base station sends a DCI to the UE indicating activation of SPS, and receives a HARQ-ACK for the DCI. Subsequently, the UE can receive DL data on the activated SPS PDSCH. In subsequent slots, as new DL data arrives, the base station sends a single scheduling DCI to the UE indicating activation of a new SPS and release of the previous SPS, such as the DCI according to at least one of the exemplary embodiments described above, and receives a HARQ-ACK for the DCI. The UE can receive the DL data on the newly activated SPS PDSCH.

### Use Example 6

This use example is suitable for varying data amount in uplink transmission. As illustrated in FIG. 8E, assume that I stream has a large data amount and P stream has a small data amount in current uplink transmission. However, the I stream to be transmitted in subsequent slots has a small data amount, whereas the P stream has a large data amount. In this case, previously configured CG may no longer be suitable after the change in traffic amount, and thus it is necessary to deactivate the previously configured CG and reactivate a CG that aligns with the subsequent traffic. According to the existing standard, two UL DCIs are required to separately indicate activation of a new CG and release of the previous CG, resulting in a significant signaling overhead and power consumption for blind detection of the DCIs. In view of this, the base station may send a DCI to activate CG and release CG simultaneously, for example, in slot D4.

FIG. 8F illustrates a communication flow diagram according to Use Example 6. As shown, the base station can configure a DCI format that may be used later for the UE via RRC signaling, such as the DCI according to the exemplary embodiments of the present disclosure, as well as a search space including PDCCH candidates for carrying the DCI. In response to the arrival of UL data stream, the base station sends a DCI to the UE indicating activation of CG, and receives a HARQ-ACK for the DCI. Subsequently, the UE can transmit UL data on the activated CG PUSCH. In subsequent slots, as new UL data arrives, the base station sends a single scheduling DCI to the UE indicating activation of a new CG and release of the previous CG, such as the DCI according to at least one of the exemplary embodiments described above, and receives a HARQ-ACK for the DCI. The UE can transmit the UL data on the newly activated CG PUSCH.

### Use Example 7

A scenario to which the present disclosure is particularly applicable, sub band full duple (SBFD) scenario, is described below.

FIG. 9 illustrates a schematic diagram of an SBFD slot format. As shown, both DL and UL exist within one slot, making it possible to indicate DL SPS and UL CG almost simultaneously. In this case, the DCI according to at least one of the exemplary embodiments of the present disclosure can be used to indicate validation (activation/release) of SPS and validation (activation/release) of CG simultaneously. Compared to using separate DCIs, the power consumption caused by DCI blind detection can be saved without any loss in performance (capacity, latency, or the like).

Next, electronic devices and communication methods to which the embodiments of the present disclosure can be applied are described.

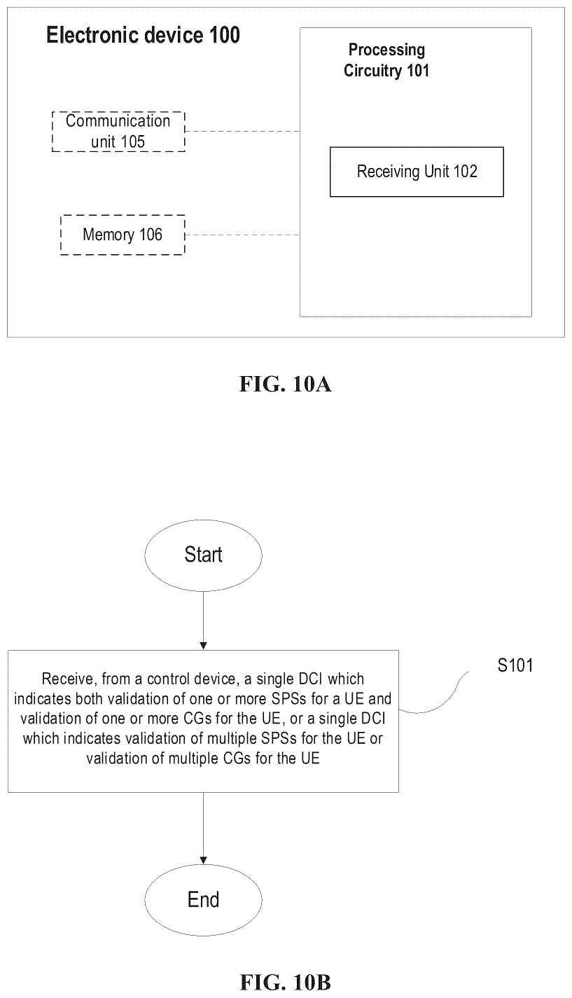

FIG. 10A illustrates a block diagram of an electronic device 100 according to the present disclosure. The electronic device 100 may be a UE or a component of the UE.

As illustrated in FIG. 10A, the electronic device 100 includes processing circuitry 101. The processing circuitry 101 comprises at least a receiving unit 102. The processing circuitry 101 may be configured to perform a communication method illustrated in FIG. 10B. The processing circuitry 101 may refer to various implementations of a digital circuit system, an analog circuit system, or a mixed-signal circuit system (a combination of analog and digital signals) that performs functions within the UE.

The receiving unit 102 of the processing circuitry 101 is configured to receive, from a control device, a single DCI indicating both validation of one or more SPSs for the UE and validation of one or more CGs for the UE, or alternatively, to receive a single DCI indicating validation of multiple SPSs for the UE or validation of multiple CGs for the UE, i.e., to perform step S101 in FIG. 10B.

As detailed in the previous exemplary embodiments, the DCI received by the receiving unit 102 may have a conventional DCI format, wherein a value of the “HARQ process number” field in the DCI is set to refer to an SPS&CG release combination in a pre-configured RRC parameter.

Alternatively, the DCI received by the receiving unit 102 may be a modified DL DCI format or UL DCI format, where its “HARQ process number” field can include multiple HARQ IDs, in which the first HARQ ID is associated with a SPS or CG to be activated or released, and subsequent HARQ ID(s) is associated with CG(s) or SPS(s) to be released. Alternatively, besides the HARQ IDs, the DCI may also include an index of a deactivation state associated with a set of SPSs or CGs to be released as the identification information thereof.

Alternatively, the DCI received by the receiving unit 102 may be a simplified DCI format, wherein its “HARQ process number” field comprises multiple HARQ IDs, each associated with a SPS and CG to be released.

Alternatively, the DCI received by the receiving unit 102 may be a synthesization of conventional DL DCI format and UL DCI format, and preferably, fields irrelevant to scheduling and validation may be omitted.

The electronic device 100 may further include a communication unit 105. The communication unit 105 can be configured to communicate with a base station under the control of the processing circuitry 101. In one example, the communication unit 105 can be implemented as a transceiver, including communication components such as an antenna array and/or RF links. The communication unit 105 is depicted with dashed lines as it may also be located outside the electronic device 100.

The electronic device 100 may further include a memory 106. The memory 106 can store various data and instructions, such as programs and data for operating the electronic device 100, various data generated by the processing circuitry 101, and various control signaling or service data transmitted or received by the communication unit 105, and so forth. The memory 106 is depicted with dashed lines as it may also be located within the processing circuitry 101 or outside the electronic device 100.

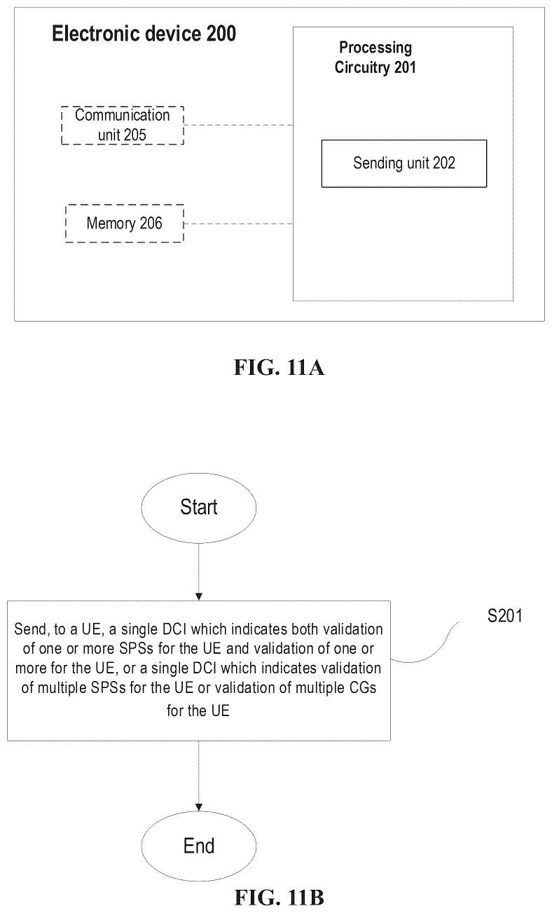

FIG. 11A illustrates a block diagram of an electronic device 200 according to the present disclosure. The electronic device 200 may be a base station device or located in the base station device.

As illustrated in FIG. 11A, the electronic device 200 includes processing circuitry 201. The processing circuitry 201 includes at least a sending unit 202. The processing circuitry 201 may be configured to perform a communication method illustrated in FIG. 11B. The processing circuitry 201 can refer to various implementations of a digital circuit system, analog circuit system, or mixed-signal circuit system (a combination of analog and digital signals) that performs functions within the base station device.

The sending unit 202 of the processing circuitry 201 is configured to send, to a UE, a single DCI indicating both validation of one or more SPSs for the UE and validation of one or more CGs for the UE, or alternatively, to send a single DCI indicating validation of multiple SPSs for the UE or validation of multiple CGs for the UE, i.e., to perform step S201 in FIG. 11B.

As detailed in the previous exemplary embodiments, the DCI sent by the sending unit 202 may have a conventional DCI format, wherein a value of the “HARQ process number” field in the DCI is set to refer to an SPS&CG release combination in a preconfigured RRC parameter.

Alternatively, the DCI sent by the sending unit 202 may be a modified DL DCI format or UL DCI format, wherein its “HARQ process number” field can include multiple HARQ IDs, in which the first HARQ ID is associated with a SPS or CG to be activated or released, and subsequent HARQ ID(s) is associated with CG(s) or SPS(s) to be released. Alternatively, besides the HARQ IDs, the DCI may also include an index of a deactivation state associated with a set of SPS(s) or CG(s) to be released as the identification information thereof.

Alternatively, the DCI sent by the sending unit 202 may be a simplified DCI format, wherein its “HARQ process number” field includes multiple HARQ IDs, each associated with a SPS or CG to be released.

Alternatively, the DCI sent by the sending unit 202 may be a synthesization of conventional DL DCI format and UL DCI format, and preferably, fields irrelevant to scheduling and validation may be omitted.

The electronic device 200 may further include a communication unit 205. The communication unit 205 can be configured to communicate with the UE under the control of the processing circuitry 201. In one example, the communication unit 205 can be implemented as a transmitter or transceiver, including communication components such as an antenna array and/or RF links. The communication unit 205 is depicted with dashed lines as it may also be located outside the electronic device 200.

The electronic device 200 may further include a memory 206. The memory 206 can store various data and instructions, programs and data for operating the electronic device 200, various data generated by the processing circuitry 201, and data to be transmitted by the communication unit 205, and so forth. The memory 206 is depicted with dashed lines as it may also be located within the processing circuitry 201 or outside the electronic device 200.

Various aspects of the embodiments of the present disclosure have been described in detail above. However, it should be noted that the structure, arrangement, type, number and the like of antenna arrays, ports, reference signals, communication devices, communication methods and the like are illustrated for purpose of description, and are not intended to limit the aspects of the present disclosure to these specific examples.

It should be understood that the units of the electronic devices 100 and 200 described in the above embodiments are only logical modules divided according to the specific functions they implement, and are not intended to limit specific implementations. In a practical implementation, the foregoing units may be implemented as individual physical entities, or may also be implemented by a single entity (for example, a processor (CPU or DSP, etc.), an integrated circuit, etc.).

It should be understood that the processing circuitry 101 and 201 described in the above embodiments may include, for example, circuitry such as integrated circuit (IC), or application specific integrated circuit (ASIC), portions or circuits of individual processor core, entire processor core, individual processor, a programmable hardware device such as field programmable gate array (FPGA), and/or a system including multiple processors. The memories 106 and 206 can be volatile memory and/or non-volatile memory. For example, the memory 106 can include but is not limited to Random-Access Memory (RAM), Dynamic Random-Access Memory (DRAM), Static Random-Access Memory (SRAM), Read-Only Memory (ROM), and flash memory.

It should be understood that the units of the electronic devices 100 and 200 described in the above embodiments are only logical modules divided according to the specific functions they implement, and are not intended to limit specific implementations. In practical implementation, the foregoing units may be implemented as individual physical entities, or may also be implemented by a single entity (for example, a processor (CPU or DSP, etc.), an integrated circuit, etc.).

### Exemplary Implementations of the Present Disclosure

According to the embodiments of the present disclosure, various implementations for practicing concepts of the present disclosure can be conceived, including but not limited to:
1). An electronic device for a control device, comprising:
processing circuitry configured to
send, to a user equipment (UE), a single Downlink Control Information (DCI) which indicates both validation of one or more Semi-Persistent Schedulings (SPSs) for the UE and validation of one or more Configured Grants (CGs) for the UE.
2). The electronic device according to 1), wherein the processing circuitry is further configured to:
configure a Radio Resource Control (RRC) parameter to the UE, the RRC parameter specifying at least one combination, each of which containing one or more SPS indices and one or more CG indices,
wherein the DCI indicates one of the at least one combination to release SPSs identified by the one or more SPS indices in the combination and CGs identified by the one or more CG indices in the combination.
3). The electronic device according to 1), wherein the DCI is a DCI for scheduling Physical Downlink Shared Channel (PDSCH), and comprises multiple HARQ IDs,
wherein the first HARQ ID in the multiple HARQ IDs is associated with a SPS to be activated or released, and one or more subsequent HARQ IDs are associated with one or more CGs to be released.
4). The electronic device according to 1), wherein the DCI is a DCI for scheduling Physical Uplink Shared Channel (PUSCH), and comprises multiple HARQ IDs,
wherein the first HARQ ID in the multiple HARQ IDs is associated with a CG to be activated or released, and one or more subsequent HARQ IDs are associated with one or more SPSs to be released.
5). The electronic device according to 1), wherein the DCI comprises multiple HARQ IDs which include HARQ IDs associated with one or more SPSs to be released and HARQ IDs associated with one or more CGs to be released,
wherein the DCI is simplified to not include at least the following fields: DCI format identifier, new data indicator (NDI), data field indicator (DFI) flag, time-domain resource assignment, frequency-domain resource assignment, PDSCH-to-HARQ feedback timing indicator, redundancy version (RV), or modulation and coding scheme (MCS).
6). The electronic device according to 1), wherein the DCI is synthesized by a downlink DCI for scheduling Physical Downlink Shared Channel (PDSCH) and an uplink DCI for scheduling Physical Uplink Shared Channel (PUSCH), wherein the downlink DCI includes the validation of the one or more SPSs, and the uplink DCI includes the validation of the one or more CGs.
7). The electronic device according to 5) or 6), wherein the processing circuitry is further configured to:
configure a format of the DCI and configure Physical Downlink Control Channel (PDCCH) containing the DCI in a search space for the UE, via RRC signaling.
8). The electronic device according to 6), wherein the downlink DCI has any of the following formats: DCI format 0_0, DCI format 0_1, or DCI format 0_2, and the uplink DCI has any of the following formats: DCI format 1_0, DCI format 1_1, or DCI format 1_2.
9). The electronic device according to 6), wherein the DCI does not include at least one of the following fields: DCI format identifier, redundancy version, new data indicator, or data field indicator (DFI) flag.
10). An electronic device for a user equipment (UE), comprising: processing circuitry configured to
receive, from a control device, a single Downlink Control Information (DCI) which indicates both validation of one or more Semi-Persistent Schedulings (SPSs) for the UE and validation of one or more Configured Grant (CGs) for the UE.
11). The electronic device according to 10), wherein the processing circuitry is further configured to:
receive, from the control device, a Radio Resource Control (RRC) parameter, the RRC parameter specifying at least one combination, each of which contains one or more SPS indices and one or more CG indices,
wherein the DCI indicates one of the at least one combination to release SPSs identified by the one or more SPS indices in the combination and CGs identified by the one or more CG indices in the combination.
12). The electronic device according to 10), wherein the DCI is a DCI for scheduling Physical Downlink Shared Channel (PDSCH), and comprises multiple HARQ IDs,
wherein the first HARQ ID in the multiple HARQ IDs is associated with a SPS to be activated or released, and one or more subsequent HARQ IDs are associated with one or more CGs to be released.
13). The electronic device according to 10), wherein the DCI is a DCI for scheduling Physical Uplink Shared Channel (PUSCH), and comprises multiple HARQ IDs,
wherein the first HARQ ID in the multiple HARQ IDs is associated with a CG to be activated or released, and one or more subsequent HARQ IDs are associated with one or more SPSs to be released.
14). The electronic device according to 10), wherein the DCI comprises multiple HARQ IDs which include HARQ IDs associated with one or more SPSs to be released and HARQ IDs associated with one or more CGs to be released,
wherein the DCI is simplified to not include at least the following fields: DCI format identifier, new data indicator (NDI), data field indicator (DFI) flag, time-domain resource assignment, frequency-domain resource assignment, PDSCH-to-HARQ feedback timing indicator, redundancy version (RV), or modulation and coding scheme (MCS).
15). The electronic device according to 10), wherein the DCI is a synthesized DCI synthesized by a downlink DCI for scheduling Physical Downlink Shared Channel (PDSCH) and an uplink DCI for scheduling Physical Uplink Shared Channel (PUSCH), wherein the downlink DCI includes the validation of the one or more SPSs, and the uplink DCI includes the validation of the one or more CGs.
16). The electronic device according to 14) or 15), wherein the processing circuitry is further configured to:
receive, via RRC signaling, a format of the DCI and configuration of Physical Downlink Control Channel (PDCCH) containing the DCI in a search space for the UE.
17). The electronic device according to 15), wherein the downlink DCI has any of the following formats: DCI format 0_0, DCI format 0_1, or DCI format 0_2, and the uplink DCI has any of the following formats: DCI format 1_0, DCI format 1_1, or DCI format 1_2.
18). The electronic device according to 15), wherein the DCI does not include at least one of the following fields: DCI format identifier, redundancy version, new data indicator, or data field indicator (DFI) flag.
19). An electronic device for a control device, comprising:
processing circuitry configured to
send, to a user equipment (UE), a single Downlink Control Information (DCI) which indicates validation of multiple Semi-Persistent Schedulings (SPSs) or multiple Configured Grants (CGs) for the UE, the DCI comprising multiple HARQ IDs,
wherein the first HARQ ID in the multiple HARQ IDs is associated with a SPS or CG to be activated or released, and one or more subsequent HARQ IDs are associated with one or more SPSs or CGs to be released.
20. An electronic device for a user equipment (UE), comprising:
processing circuitry configured to
receive, from a control device, a single Downlink Control Information (DCI) which indicates validation of multiple Semi-Persistent Schedulings (SPSs) or multiple Configured Grants (CGs) for the UE, the DCI comprising multiple HARQ IDs,
wherein the first HARQ ID in the multiple HARQ IDs is associated with a SPS or CG to be activated or released, and one or more subsequent HARQ IDs are associated with one or more SPSs or CGs to be released.
21). A communication method, comprising:
sending, to a user equipment (UE), a single Downlink Control Information (DCI) which indicates both validation of one or more Semi-Persistent Schedulings (SPSs) for the UE and validation of one or more Configured Grants (CGs) for the UE.
22). A communication method, comprising:
receiving, from a control device, a single Downlink Control Information (DCI) which indicates both validation of one or more Semi-Persistent Schedulings (SPSs) and validation of one or more Configured Grants (CGs) for the UE.
23). A computer program product comprising executable instructions which, when executed, implement the communication method according to any of Claims 25-28.

### Application Examples of the Present Disclosure

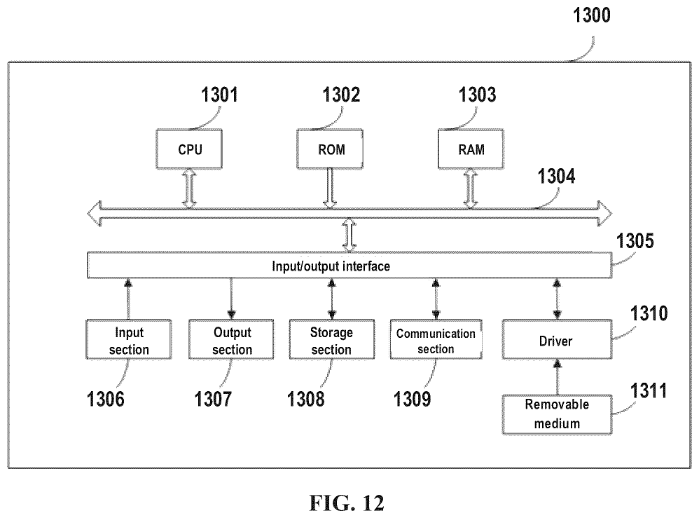

FIG. 12 illustrates an example block diagram of a computer that can be implemented as a terminal device or a control device according to the embodiments of the present disclosure.

In FIG. 12, a central processing unit (CPU) 1301 performs various processing based on programs stored in a Read-Only Memory (ROM) 1302 or programs loaded into a Random Access Memory (RAM) 1303 from a storage section 1308. Data required by CPU 1301 for performing various processing, and so forth, is also stored in RAM 1303 as needed.

CPU 1301, ROM 1302, and RAM 1303 are interconnected via a bus 1304. An input/output interface 1305 is also connected to bus 1304.

The following components are connected to the input/output interface 1305: an input section 1306 including a keyboard, a mouse and so forth; an output section 1307 including a display such as a cathode ray tube (CRT), a liquid crystal display (LCD) or the like, and a speaker, and so forth; a storage section 1308 including a hard disk and the like; and a communication section 1309 including network interface cards such as a LAN card or a modem, or the like. The communication section 1309 performs communication processing via networks such as the Internet.

As needed, a driver 1310 is also connected to the input/output interface 1305. A removable medium 1311, such as a magnetic disk, optical disk, magneto-optical disk, semiconductor memory, etc., is mounted on the driver 1310 as needed, enabling computer programs read from the removable medium 1311 to be installed in the storage section 1308 as needed.

When the above series of processing is implemented by software, the programs constituting the software are installed from a network such as the Internet or a storage medium such as the removable medium 1311.

It should be understood by those skilled in the art that such a storage medium is not limited to the removable medium 1311 shown in FIG. 12, which stores a program and is distributed separately from a device to provide the programs to a user. Examples of the removable medium 1311 include magnetic disks (including floppy disks (registered trademark)), optical disks (including compact disc read-only memory (CD-ROM) and digital versatile discs (DVD)), magneto-optical disks (including mini-discs (MD) (registered trademark)), and semiconductor memory. Alternatively, the storage medium can be the ROM 1302, hard disk included in the storage section 1308, and so forth, in which programs are stored and distributed to users along with the device containing them.

The technology of the present disclosure can be applied to various products.

For example, the electronic device 200 according to the embodiments of the present disclosure can be implemented as or installed in a variety of base stations, and the electronic device 100 can be implemented as or installed in a variety of user devices.

The communication methods according to the embodiments of the present disclosure may be implemented by various base stations or user devices; the methods and operations according to the embodiments of the present disclosure may be embodied as computer-executable instructions, stored in a non-transitory computer-readable storage medium, and can be performed by various base stations or user devices to implement one or more of the above-mentioned functions.

The technology according to the embodiments of the present disclosure can be made into various computer program products, which can be used in various base stations or user devices to implement one or more of the above-mentioned functions.

The base stations mentioned in the present disclosure can be implemented as any type of base stations, preferably, such as the macro gNB or ng-eNB defined in the 3GPP 5G NR standard. A gNB may be a gNB that covers a cell smaller than a macro cell, such as a pico gNB, a micro gNB, and a home (femto) gNB. Instead, the base station may be implemented as any other types of base stations such as a NodeB, an eNodeB and a base transceiver station (BTS). The base station may include a main body configured to control wireless communication, and one or more remote radio heads (RRH), a wireless relay, a drone control tower, a control node in an automated factory or the like disposed in a different place from the main body.

The user device may be implemented as a mobile terminal such as a smartphone, a tablet personal computer (PC), a notebook PC, a portable game terminal, a portable/dongle type mobile router, and a digital camera apparatus, or an in-vehicle terminal such as a car navigation device. The user device may also be implemented as a terminal (that is also referred to as a machine type communication (MTC) terminal) that performs machine-to-machine (M2M) communication, a drone, a sensor or actuator in an automated factory or the like. Furthermore, the user device may be a wireless communication module (such as an integrated circuit module including a single die) mounted on each of the above terminals.

### First Application Example of Base Station

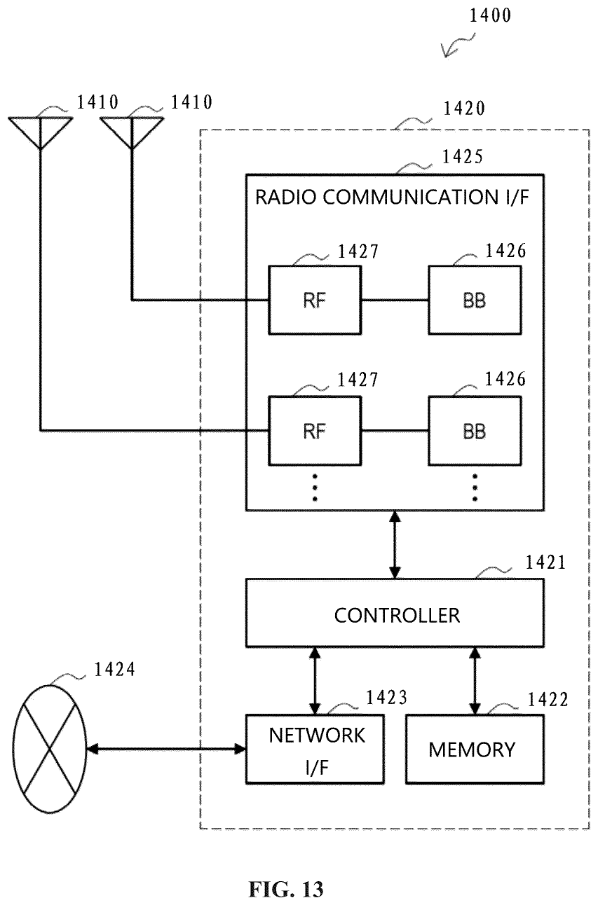

FIG. 13 is a block diagram showing a first example of a schematic configuration of a base station to which the technology of the present disclosure can be applied. In FIG. 13, the base station is implemented as gNB 1400. The gNB 1400 includes a plurality of antennas 1410 and a base station device 1420. The base station device 1420 and each antenna 1410 may be connected to each other via an RF cable. In an implementation, the gNB 1400 (or the base station device 1420) herein may correspond to the above-mentioned base station device 200.

The antennas 1410 includes multiple antenna elements. The antennas 1410, for example, can be arranged into a matrix of antenna arrays, and are used by the base station device 1420 to transmit and receive wireless signals. For example, multiple antennas 1410 may be compatible with multiple frequency bands used by gNB 1400.

The base station device 1420 includes a controller 1421, a memory 1422, a network interface 1423, and a radio communication interface 1425.

The controller 1421 may be, for example, a CPU or a DSP, and operates various functions of the base station device 1420 at a higher layer. For example, the controller 1421 may include the processing circuitry 201 as described above, perform the communication method described in FIG. 111B, or control various components of the base station device 200. For example, the controller 1421 generates data packets based on data in signals processed by the radio communication interface 1425, and passes the generated packets via the network interface 1423. The controller 1421 may bundle data from multiple baseband processors to generate bundled packets, and pass the generated bundled packets. The controller 1421 may have logical functions that perform controls such as radio resource control, radio bearer control, mobility management, admission control, and scheduling. The controls can be performed in conjunction with a nearby gNB or core network node. The memory 1422 includes a RAM and a ROM, and stores a program executed by the controller 1421 and various types of control data such as a terminal list, transmission power data, and scheduling data.

The network interface 1423 is a communication interface for connecting the base station device 1420 to the core network 1424 (e.g. 5G core network). The controller 1421 may communicate with a core network node or another gNB via the network interface 1423. In this case, the gNB 1400 and the core network node or other gNBs may be connected to each other through a logical interface such as an NG interface and an Xn interface. The network interface 1423 may also be a wired communication interface or a radio communication interface for a wireless backhaul line. If the network interface 1423 is a radio communication interface, compared with the frequency band used by the radio communication interface 1425, the network interface 1423 can use a higher frequency band for wireless communication.

The radio communication interface 1425 supports any cellular communication scheme such as 5G NR, and provides a wireless connection to a terminal located in a cell of the gNB 1400 via an antenna 1410. The radio communication interface 1425 may generally include, for example, a baseband (BB) processor 1426 and an RF circuit 1427. The BB processor 1426 may perform, for example, encoding/decoding, modulation/demodulation, and multiplexing/demultiplexing, and execute various types of signal processing in layers such as the physical layer, the MAC layer, the RLC layer, the PDCP layer, and the SDAP layer. As an alternative of the controller 1421, the BB processor 1426 may have a part or all of the above-mentioned logical functions. The BB processor 1426 may be a memory storing a communication control program, or a module including a processor and related circuits configured to execute the program. Updating the program can change the function of the BB processor 1426. The module may be a card or a blade inserted into a slot of the base station device 1420. Alternatively, the module may be a chip mounted on a card or a blade. Meanwhile, the RF circuit 1427 may include, for example, a mixer, a filter, and an amplifier, and transmits and receives a wireless signal via the antenna 1410. Although FIG. 13 illustrates an example in which one RF circuit 1427 is connected to one antenna 1410, the present disclosure is not limited to this illustration, but one RF circuit 1427 may be connected to multiple antennas 1410 at the same time.

As shown in FIG. 13, the radio communication interface 1425 may include a plurality of BB processors 1426. For example, the plurality of BB processors 1426 may be compatible with multiple frequency bands used by gNB 1400. As shown in FIG. 13, the radio communication interface 1425 may include a plurality of RF circuits 1427. For example, the plurality of RF circuits 1427 may be compatible with multiple antenna elements. Although FIG. 13 shows an example in which the radio communication interface 1425 includes a plurality of BB processors 1426 and a plurality of RF circuits 1427, the radio communication interface 1425 may also include a single BB processor 1426 or a single RF circuit 1427.

In the gNB 1400 illustrated in FIG. 13, one or more of the units included in the processing circuitry 201 (for example, the sending unit 202) described with reference to FIG. 11A may be implemented in the radio communication interface 1425. Alternatively, at least a part of these components may be implemented in the controller 1421. As an example, the gNB 1400 includes a part (for example, the BB processor 1426) or the entire of the radio communication interface 1425 and/or a module including the controller 1421, and the one or more components may be implemented in the module. In this case, the module may store a program for allowing the processor to function as the one or more components (in other words, a program for allowing the processor to perform operations of the one or more components), and may execute the program. As another example, a program for allowing the processor to function as the one or more components may be installed in the gNB 1400, and the radio communication interface 1425 (for example, the BB processor 1426) and/or the controller 1421 may execute the program. As described above, as a device including the one or more components, the gNB 1400, the base station device 1420 or the module may be provided, as well as the program for allowing processor to function as the one or more components may be provided. In addition, a readable medium in which the program is recorded may be provided.

### Second Application Example of Base Station

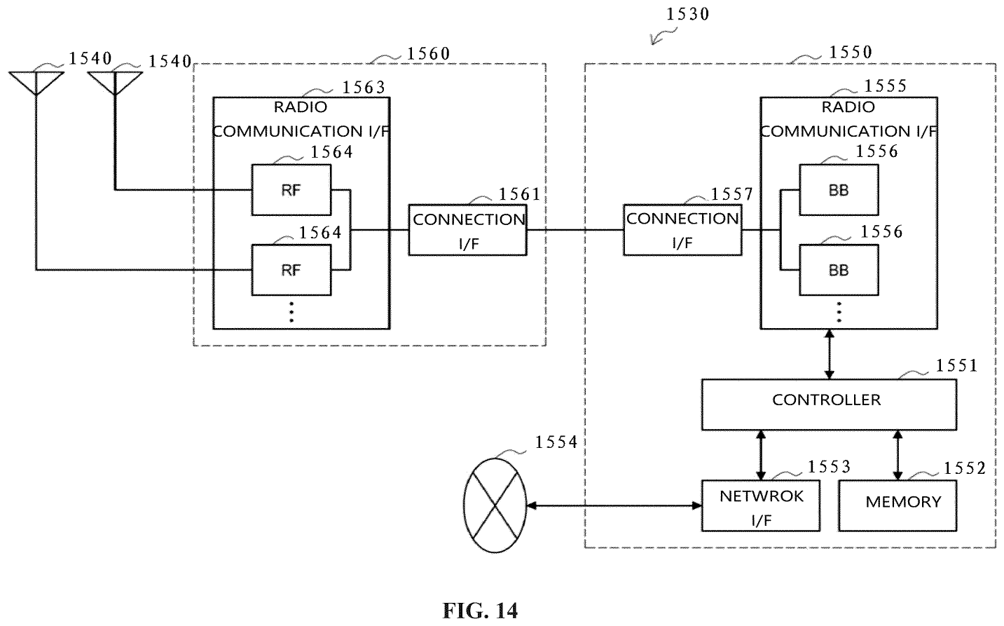

FIG. 14 is a block diagram showing a second example of a schematic configuration of a base station to which the technology of the present disclosure can be applied. In FIG. 14, the base station is shown as gNB 1530. The gNB 1530 includes multiple antennas 1540, base station device 1550, and RRH 1560. The RRH 1560 and each antenna 1540 may be connected to each other via an RF cable. The base station device 1550 and the RRH 1560 may be connected to each other via a high-speed line such as a fiber optic cable. In an implementation, the gNB 1530 (or the base station device 1550) herein may correspond to the above-mentioned base station device 200.

The antennas 1540 includes multiple antenna elements. The antennas 1540, for example, can be arranged into a matrix of antenna arrays, and are used by the base station device 1550 to transmit and receive wireless signals. For example, multiple antennas 1540 may be compatible with multiple frequency bands used by gNB 1530.

The base station device 1550 includes a controller 1551, a memory 1552, a network interface 1553, a radio communication interface 1555, and a connection interface 1557. The controller 1551, the memory 1552, and the network interface 1553 are the same as the controller 1421, the memory 1422, and the network interface 1423 described with reference to FIG. 13.

The radio communication interface 1555 supports any cellular communication scheme such as 5G NR, and provides wireless communication to a terminal located in a sector corresponding to the RRH 1560 via the RRH 1560 and the antenna 1540. The radio communication interface 1555 may generally include, for example, a BB processor 1556. The BB processor 1556 is the same as the BB processor 1426 described with reference to FIG. 13 except that the BB processor 1556 is connected to the RF circuit 1564 of the RRH 1560 via the connection interface 1557. As shown in FIG. 14, the radio communication interface 1555 may include a plurality of BB processors 1556. For example, multiple BB processors 1556 may be compatible with multiple frequency bands used by gNB 1530. Although FIG. 14 shows an example in which the radio communication interface 1555 includes a plurality of BB processors 1556, the radio communication interface 1555 may also include a single BB processor 1556.

The connection interface 1557 is an interface for connecting the base station device 1550 (radio communication interface 1555) to the RRH 1560. The connection interface 1557 may also be a communication module for communication in the above-mentioned high-speed line connecting the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module for communication in the above-mentioned high-speed line.

The radio communication interface 1563 transmits and receives wireless signals via the antenna 1540. The radio communication interface 1563 may generally include, for example, an RF circuit 1564. The RF circuit 1564 may include, for example, a mixer, a filter, and an amplifier, and transmits and receives wireless signals via the antenna 1540. Although FIG. 14 illustrates an example in which one RF circuit 1564 is connected to one antenna 1540, the present disclosure is not limited to this illustration, but one RF circuit 1564 may be connected to multiple antennas 1540 at the same time.

As shown in FIG. 14, the radio communication interface 1563 may include a plurality of RF circuits 1564. For example, the plurality of RF circuits 1564 may support multiple antenna elements. Although FIG. 14 shows an example in which the radio communication interface 1563 includes a plurality of RF circuits 1564, the radio communication interface 1563 may include a single RF circuit 1564.

In the gNB 1500 shown in FIG. 14, one or more of the units included in the processing circuitry 201 (for example, the sending unit 202) described with reference to FIG. 11A may be implemented in the radio communication interface 1525. Alternatively, at least a part of these components may be implemented in the controller 1521. For example, the gNB 1500 includes a part (for example, the BB processor 1526) or the entire of the radio communication interface 1525, and/or a module including the controller 1521, and one or more components may be implemented in the module. In this case, the module may store a program for allowing the processor to function as one or more components (in other words, a program for allowing the processor to perform operations of one or more components), and may execute the program. As another example, a program for allowing the processor to function as one or more components may be installed in the gNB 1500, and the radio communication interface 1525 (for example, the BB processor 1526) and/or the controller 1521 may execute the program. As described above, as a device including one or more components, the gNB 1500, the base station device 1520, or a module may be provided, and a program for allowing the processor to function as one or more components may be provided. In addition, a readable medium in which the program is recorded may be provided.

### First Application Example of User Equipment

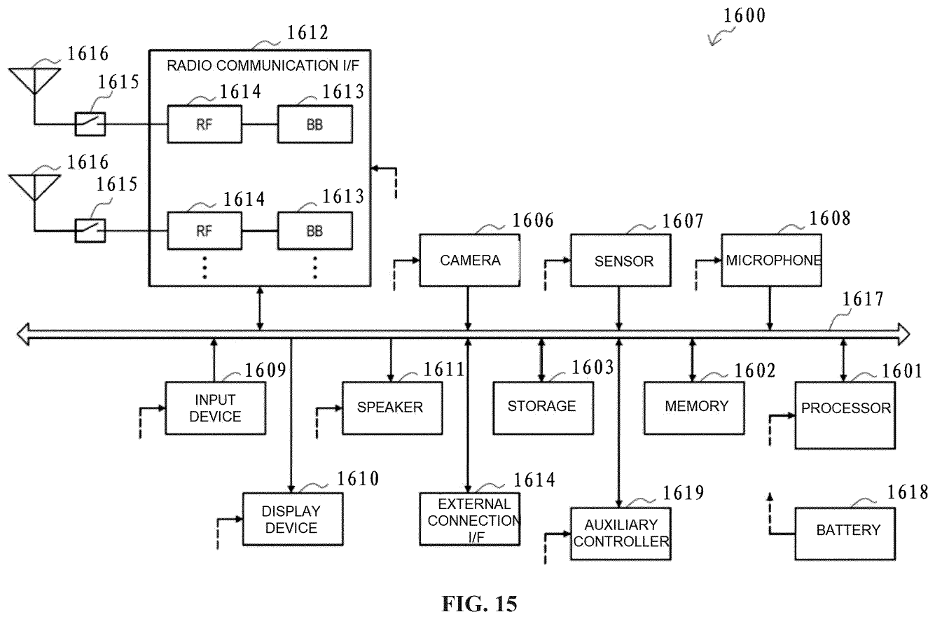

FIG. 15 is a block diagram showing an example of a schematic configuration of a smartphone 1600 to which the technology of the present disclosure can be applied. In an example, the smart phone 1600 may be implemented as the electronic device 100 described in the present disclosure.

The smartphone 1600 includes a processor 1601, a memory 1602, a storage device 1603, an external connection interface 1604, a camera device 1606, a sensor 1607, a microphone 1608, an input device 1609, a display device 1610, a speaker 1611, a radio communication interface 1612, one or more antenna switches 1615, one or more antennas 1616, a bus 1617, a battery 1618, and an auxiliary controller 1619.

The processor 1601 may be, for example, a CPU or a system on chip (SoC), and controls functions of an application layer and another layer of the smartphone 1600. The processor 1601 may include or serve as the processing circuitry 101 described with reference to FIG. 10A. The memory 1602 includes a RAM and a ROM, and stores data and programs executed by the processor 1601 for implementing the communication method described with reference to FIG. 10B. The storage device 1603 may include a storage medium such as a semiconductor memory and a hard disk. The external connection interface 1604 is an interface for connecting external devices such as a memory card and a universal serial bus (USB) device to the smartphone 1600.

The camera device 1606 includes an image sensor such as a charge-coupled device (CCD) and a complementary metal oxide semiconductor (CMOS), and generates a captured image. The sensor 1607 may include a set of sensors such as a measurement sensor, a gyroscope sensor, a geomagnetic sensor, and an acceleration sensor. The microphone 1608 converts a sound input to the smartphone 1600 into an audio signal. The input device 1609 includes, for example, a touch sensor, a keypad, a keyboard, a button, or a switch configured to detect a touch on the screen of the display device 1610, and receives an operation or information input from a user. The display device 1610 includes a screen such as a liquid crystal display (LCD) and an organic light emitting diode (OLED) display, and displays an output image of the smartphone 1600. The speaker 1611 converts an audio signal output from the smartphone 1600 into a sound.

The radio communication interface 1612 supports any cellular communication scheme such as 4G LTE, 5G NR or the like, and performs wireless communication. The radio communication interface 1612 may generally include, for example, a BB processor 1613 and an RF circuit 1614. The BB processor 1613 may perform, for example, encoding/decoding, modulation/demodulation, and multiplexing/demultiplexing, and perform various types of signal processing for wireless communication. Meanwhile, the RF circuit 1614 may include, for example, a mixer, a filter, and an amplifier, and transmits and receives wireless signals via the antenna 1616. The radio communication interface 1612 may be a chip module on which a BB processor 1613 and an RF circuit 1614 are integrated. As shown in FIG. 15, the radio communication interface 1612 may include multiple BB processors 1613 and multiple RF circuits 1614. Although FIG. 15 illustrates an example in which the radio communication interface 1612 includes a plurality of BB processors 1613 and a plurality of RF circuits 1614, the radio communication interface 1612 may also include a single BB processor 1613 or a single RF circuit 1614.

In addition, in addition to the cellular communication scheme, the radio communication interface 1612 may support other types of wireless communication scheme, such as a short-range wireless communication scheme, a near field communication scheme, and a wireless local area network (LAN) scheme. In this case, the radio communication interface 1612 may include a BB processor 1613 and an RF circuit 1614 for each wireless communication scheme.

Each of the antenna switches 1615 switches a connection destination of the antenna 1616 between a plurality of circuits included in the radio communication interface 1612 (for example, circuits for different wireless communication schemes).

The antennas 1616 includes multiple antenna elements. The antennas 1616, for example, can be arranged into a matrix of antenna arrays, and are used by the radio communication interface 1612 to transmit and receive wireless signals. The smart phone 1600 can includes one or more antenna panels (not shown).

In addition, the smartphone 1600 may include an antenna 1616 for each wireless communication scheme. In this case, the antenna switch 1615 may be omitted from the configuration of the smartphone 1600.

The bus 1617 connects the processor 1601, the memory 1602, the storage device 1603, the external connection interface 1604, the camera device 1606, the sensor 1607, the microphone 1608, the input device 1609, the display device 1610, the speaker 1611, the radio communication interface 1612, and the auxiliary controller 1619 to each other. The battery 1618 supplies power to each block of the smartphone 1600 shown in FIG. 15 via a feeder, and the feeder is partially shown as a dashed line in the figure. The auxiliary controller 1619 operates the minimum necessary functions of the smartphone 1600 in the sleep mode, for example.

In the smart phone 1600 shown in FIG. 15, one or more components included the processing circuitry may be implemented in the radio communication interface 1612, such as the sending unit 102 of the processing circuitry 101 described with reference to FIG. 10A. Alternatively, at least a part of these components may be implemented in the processor 1601 or the auxiliary controller 1619. As an example, the smart phone 1600 includes a part (for example, the BB processor 1613) or the entire of the radio communication interface 1612, and/or a module including the processor 1601 and/or the auxiliary controller 1619, and one or more components may be implemented in this module. In this case, the module may store a program for allowing the processor to function as one or more components (in other words, a program for allowing the processor to perform operations of one or more components), and may execute the program. As another example, a program for allowing the processor to function as one or more components may be installed in the smart phone 1600, and the radio communication interface 1612 (for example, the BB processor 1613), the processor 1601, and/or the auxiliary controller 1619 can execute this program. As described above, as a device including one or more components, a smart phone 1600 or a module may be provided, and a program for allowing a processor to function as one or more components may be provided. In addition, a readable medium in which the program is recorded may be provided.

### Second Application Example of User Device

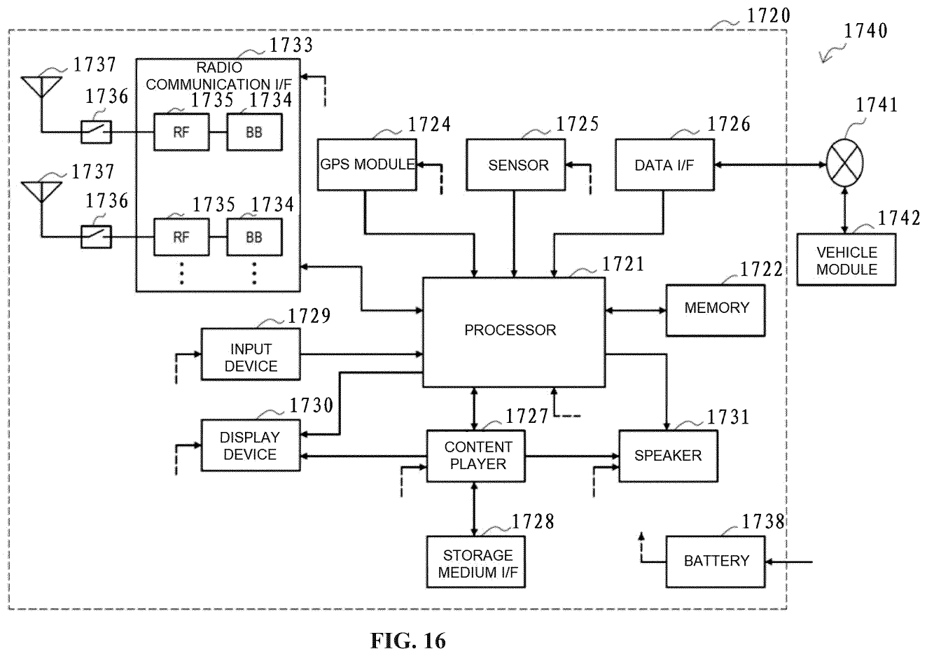

FIG. 16 is a block diagram showing an example of a schematic configuration of a car navigation device 1720 to which the technology of the present disclosure can be applied. The car navigation device 1720 can be implemented as the electronic device 100 described with reference to FIG. 10A. The car navigation device 1720 includes a processor 1721, a memory 1722, a Global Positioning System (GPS) module 1724, a sensor 1725, a data interface 1726, a content player 1727, a storage medium interface 1728, an input device 1729, a display device 1730, a speaker 1731, and a radio communication interface 1733, one or more antenna switches 1736, one or more antennas 1737, and a battery 1738. In one example, the car navigation device 1720 may be implemented as a UE described in the present disclosure.

The processor 1721 may be, for example, a CPU or a SoC, and controls navigation functions and other functions of the car navigation device 1720. The memory 1722 includes a RAM and a ROM, and stores data and programs executed by the processor 1721.

The GPS module 1724 uses a GPS signal received from a GPS satellite to measure the position (such as latitude, longitude, and altitude) of the car navigation device 1720. The sensor 1725 may include a set of sensors such as a gyroscope sensor, a geomagnetic sensor, and an air pressure sensor. The data interface 1726 is connected to, for example, an in-vehicle network 1741 via a terminal not shown, and acquires data (such as vehicle speed data) generated by the vehicle.

The content player 1727 reproduces content stored in a storage medium such as a CD and a DVD, which is inserted into the storage medium interface 1728. The input device 1729 includes, for example, a touch sensor, a button, or a switch configured to detect a touch on the screen of the display device 1730, and receives an operation or information input from a user. The display device 1730 includes a screen such as an LCD or OLED display, and displays an image of a navigation function or reproduced content. The speaker 1731 outputs the sound of the navigation function or the reproduced content.

The radio communication interface 1733 supports any cellular communication scheme such as 4G LTE or 5G NR, and performs wireless communication. The radio communication interface 1733 may generally include, for example, a BB processor 1734 and an RF circuit 1735. The BB processor 1734 may perform, for example, encoding/decoding, modulation/demodulation, and multiplexing/demultiplexing, and perform various types of signal processing for wireless communication. Meanwhile, the RF circuit 1735 may include, for example, a mixer, a filter, and an amplifier, and transmit and receive wireless signals via the antenna 1737. The radio communication interface 1733 may also be a chip module on which a BB processor 1734 and an RF circuit 1735 are integrated. As shown in FIG. 15, the radio communication interface 1733 may include a plurality of BB processors 1734 and a plurality of RF circuits 1735. Although FIG. 15 shows an example in which the radio communication interface 1733 includes a plurality of BB processors 1734 and a plurality of RF circuits 1735, the radio communication interface 1733 may also include a single BB processor 1734 or a single RF circuit 1735.

In addition, in addition to the cellular communication scheme, the radio communication interface 1733 may support other types of wireless communication scheme, such as a short-range wireless communication scheme, a near field communication scheme, and a wireless LAN scheme. In this case, the radio communication interface 1733 may include a BB processor 1734 and an RF circuit 1735 for each wireless communication scheme.

Each of the antenna switches 1736 switches the connection destination of the antenna 1737 between a plurality of circuits (for example, circuits for different wireless communication schemes) included in the radio communication interface 1733.

The antennas 1737 includes multiple antenna elements. The antennas 1737, for example, can be arranged into a matrix of antenna arrays, and are used by the radio communication interface 1733 to transmit and receive wireless signals.

In addition, the car navigation device 1720 may include an antenna 1737 for each wireless communication scheme. In this case, the antenna switch 1736 may be omitted from the configuration of the car navigation device 1720.

The battery 1738 supplies power to each block of the car navigation device 1720 shown in FIG. 15 via a feeder, and the feeder is partially shown as a dashed line in the figure. The battery 1738 accumulates power provided from the vehicle.

In the car navigation device 1720 shown in FIG. 15, one or more components included in processing circuitry may be implemented in the radio communication interface 1733, such as the sending unit 102 of the processing circuitry 101 described with reference to FIG. 10A. Alternatively, at least a part of these components may be implemented in the processor 1721. As an example, the car navigation device 1720 includes a part (for example, the BB processor 1734) or the entire of the radio communication interface 1733, and/or a module including the processor 1721, and one or more components may be implemented in the module. In this case, the module may store a program for allowing the processor to function as one or more components (in other words, a program for allowing the processor to perform operations of one or more components), and may execute the program. As another example, a program for allowing the processor to function as one or more components may be installed in the car navigation device 1720, and the radio communication interface 1733 (for example, the BB processor 1734) and/or the processor 1721 may Execute the program. As described above, as a device including one or more components, a car navigation device 1720 or a module may be provided, and a program for allowing the processor to function as one or more components may be provided. In addition, a readable medium in which the program is recorded may be provided.

The technology of the present disclosure may also be implemented as an in-vehicle system (or vehicle) 1740 including one or more of a car navigation device 1720, an in-vehicle network 1741, and a vehicle module 1742. The vehicle module 1742 generates vehicle data such as vehicle speed, engine speed, and failure information, and outputs the generated data to the in-vehicle network 1741.

Although the exemplary embodiments of the present disclosure have been described with reference to the accompanying drawings, the present disclosure is certainly not limited to the above examples. Those skilled in the art may achieve various adaptions and modifications within the scope of the appended claims, and it will be appreciated that these adaptions and modifications certainly fall into the scope of the technology of the present disclosure.

For example, in the above embodiments, the multiple functions included in one unit may be implemented by separate devices. Alternatively, in the above embodiments, the multiple functions implemented by multiple units may be implemented by separate devices, respectively. In additions, one of the above functions may be implemented by multiple units. Needless to say, such configurations are included in the scope of the technology of the present disclosure.

In this specification, the steps described in the flow diagrams include not only the processes performed sequentially in chronological order, but also the processes performed in parallel or separately but not necessarily performed in chronological order. Furthermore, even in the steps performed in chronological order, needless to say, the order may be changed appropriately.

Although the present disclosure and its advantages have been described in detail, it will be appreciated that various changes, replacements and transformations may be made without departing from the spirit and scope of the present disclosure as defined by the appended claims. In addition, the terms “include”, “comprise” or any other variants of the embodiments of the present disclosure are intended to be non-exclusive inclusion, such that the process, method, article or device including a series of elements includes not only these elements, but also those that are not listed specifically, or those that are inherent to the process, method, article or device. In case of further limitations, the element defined by the sentence “include one” does not exclude the presence of additional same elements in the process, method, article or device including this element.

1. An electronic device for a control device, comprising:
processing circuitry configured to
send, to a user equipment (UE), a single Downlink Control Information (DCI) which indicates both validation of one or more Semi-Persistent Schedulings (SPSs) for the UE and validation of one or more Configured Grants (CGs) for the UE.

2. The electronic device according to claim 1, wherein the processing circuitry is further configured to:
configure a Radio Resource Control (RRC) parameter to the UE, the RRC parameter specifying at least one combination, each of which containing one or more SPS indices and one or more CG indices,
wherein the DCI indicates one of the at least one combination to release SPSs identified by the one or more SPS indices in the combination and CGs identified by the one or more CG indices in the combination.

3. The electronic device according to claim 1, wherein the DCI is a DCI for scheduling Physical Downlink Shared Channel (PDSCH), and includes identification information associated with a SPS to be activated or released and identification information associated with one or more CGs to be released, or
wherein the DCI is a DCI for scheduling Physical Uplink Shared Channel (PUSCH), and includes identification information associated with a CG to be activated or released and identification information associated with one or more SPSs or CGs to be released.

4. (canceled)

5. The electronic device according to claim 1, wherein the DCI is a simplified DCI, and includes identification information associated with one or more SPSs to be released and identification information associated with one or more CGs to be released,
wherein the simplified DCI does not include at least the following fields: DCI format identifier, new data indicator (NDI), data field indicator (DFI) flag, time-domain resource assignment, frequency-domain resource assignment, PDSCH-to-HARQ feedback timing indicator, redundancy version (RV), or modulation and coding scheme (MCS), or
wherein the DCI is a synthesized DCI synthesized by a downlink DCI for scheduling Physical Downlink Shared Channel (PDSCH) and an uplink DCI for scheduling Physical Uplink Shared Channel (PUSCH), wherein the downlink DCI includes the validation of the one or more SPSs, and the uplink DCI includes the validation of the one or more CGs.

6. (canceled)

7. The electronic device according to claim 1, wherein the processing circuitry is further configured to:
configure a format of the DCI and configure Physical Downlink Control Channel (PDCCH) containing the DCI in a search space for the UE, via RRC signaling.

8. The electronic device according to claim 1, wherein the identification information includes HARQ IDs associated with individual SPSs or CGs, or an index associated with a set of SPSs, a set of CGs, or a set containing both SPSs and CGs.

9. The electronic device according to claim 5, wherein the synthesized DCI does not include at least one of the following fields: DCI format identifier, redundancy version, new data indicator, or data field indicator (DFI) flag.

10. An electronic device for a user equipment (UE), comprising:
processing circuitry configured to
receive, from a control device, a single Downlink Control Information (DCI) which indicates both validation of one or more Semi-Persistent Schedulings (SPSs) for the UE and validation of one or more Configured Grant (CGs) for the UE.

11. The electronic device according to claim 10, wherein the processing circuitry is further configured to:
receive, from the control device, a Radio Resource Control (RRC) parameter, the RRC parameter specifying at least one combination, each of which contains one or more SPS indices and one or more CG indices,
wherein the DCI indicates one of the at least one combination to release SPSs identified by the one or more SPS indices in the combination and CGs identified by the one or more CG indices in the combination.

12. The electronic device according to claim 10, wherein the DCI is a DCI for scheduling Physical Downlink Shared Channel (PDSCH), and includes identification information associated with a SPS to be activated or released and identification information associated with one or more CGs or SPSs to be released, or
wherein the DCI is a DCI for scheduling Physical Uplink Shared Channel (PUSCH), and includes identification information associated with a CG to be activated or released and identification information associated with one or more SPSs or CGs to be released.

13. (canceled)

14. The electronic device according to claim 10, wherein the DCI is a simplified DCI, and includes identification information associated with one or more SPSs to be released and identification information associated with one or more CGs to be released,
wherein the simplified DCI does not include at least the following fields: DCI format identifier, new data indicator (NDI), data field indicator (DFI) flag, time-domain resource assignment, frequency-domain resource assignment, PDSCH-to-HARQ feedback timing indicator, redundancy version (RV), or modulation and coding scheme (MCS), or
wherein the DCI is a synthesized DCI synthesized by a downlink DCI for scheduling Physical Downlink Shared Channel (PDSCH) and an uplink DCI for scheduling Physical Uplink Shared Channel (PUSCH), wherein the downlink DCI includes the validation of the one or more SPSs, and the uplink DCI includes the validation of the one or more CGs.

15. (canceled)

16. The electronic device according to claim 10, wherein the processing circuitry is further configured to:
receive, via RRC signaling, a format of the DCI and configuration of Physical Downlink Control Channel (PDCCH) containing the DCI in a search space for the UE.

17. The electronic device according to claim 10, wherein the identification information includes HARQ IDs associated with individual SPSs or CGs, or an index associated with a set of SPSs, a set of CGs, or a set containing both SPSs and CGs.

18. The electronic device according to claim 14, wherein the synthesized DCI does not include at least one of the following fields: DCI format identifier, redundancy version, new data indicator, or data field indicator (DFI) flag.

19. An electronic device for a control device, comprising:
processing circuitry configured to
send, to a user equipment (UE), a single Downlink Control Information (DCI) which indicates validation of multiple Semi-Persistent Schedulings (SPSs) for the UE or validation of multiple Configured Grants (CGs) for the UE,
wherein the DCI includes identification information associated with a SPS to be activated or released and identification information associated with one or more further SPSs to be released, or
wherein the DCI includes identification information associated with a CG to be activated or released and identification information associated with one or more further CGs to be released.

20. The electronic device according to claim 19, wherein the processing circuitry is further configured to:
configure a format of the DCI and configure Physical Downlink Control Channel (PDCCH) containing the DCI in a search space for the UE, via RRC signaling.

21. The electronic device according to claim 19, wherein the identification information includes HARQ ID associated with individual SPSs or CGs, or an index associated with a set of SPSs or a set of CGs.

22. An electronic device for a user equipment (UE), comprising:
processing circuitry configured to
receive, from a control device, a single Downlink Control Information (DCI) which indicates validation of multiple Semi-Persistent Schedulings (SPSs) for the UE or validation of multiple Configured Grants (CGs) for the UE,
wherein the DCI includes identification information associated with a SPS to be activated or released and identification information associated with one or more further SPSs to be released, or
wherein the DCI includes identification information associated with a CG to be activated or released and identification information associated with one or more further CGs to be released.

23. The electronic device according to claim 22, wherein the processing circuitry is further configured to:
configure a format of the DCI and configure Physical Downlink Control Channel (PDCCH) containing the DCI in a search space for the UE, via RRC signaling.

24. The electronic device according to claim 22, wherein the identification information includes HARQ IDs associated with individual SPSs or CGs, or an index associated with a set of SPSs or a set of CGs.

25.-29. (canceled)
